(19) United States
(12) Patent Application Publication
(10) Pub. No.: US 2009/0084821 A1
(43) Pub. Date: Apr. 2, 2009

(54) Convertible backpack frame

(76) Inventor: Marco Antonio Lenzi, Richmond, CA (US)

Correspondence Address: Marco Lenzi, 5914 Bernhard Ave., Richmond, CA, 94805, US

(21) Appl. No.: 12/284,982

(22) Filed: Sep. 26, 2008

Related U.S. Application Data
(60) Provisional application No. 60/995,570, filed on Sep. 27, 2007.

(51) Int. Cl. A45F 3/08; B23P 19/04

(52) U.S. Cl. 224/155; 29/700

(57) ABSTRACT

A convertible backpack frame usable in a first mode as a backpack frame and in a second mode as a chair frame, having a frame assembly that includes an upper member having a U-shaped first section with parallel sides having a V-shape bend in each side and a rearwardly extending U-shaped second section joined substantially perpendicular and proximate to the upper ends of the first section, a substantially rectangular lower member pivotably coupled to upper member along a transverse axis, and a lockable telescoping member coupled to each side of upper and lower members so as to control and maintain the orientation of the upper member with respect to the lower member so as to allow the upper and lower members to pivot from their first mode orientation as a backpack frame to their second mode orientation as a chair frame having a reclinable backrest frame.

### CROSS-REFERENCE TO RELATED APPLICATIONS

This application claims the benefit of Provisional Patent Application Ser. No. 60/995570, filed Sep. 27, 2007 by the inventor, Marco A. Lenzi.

### STATEMENT OF FEDERALLY SPONSORED RESEARCH/DEVELOPMENT

Not applicable.

### REFERENCE TO A SEQUENCE LISTING

Not applicable.

### BACKGROUND

1. Field of the Invention

The present invention generally relates to backpacks and more specifically it relates to an improved backpack frame with enhanced capabilities that permit the backpack frame to be converted to a reclinable chair.

2. Description of the Related Art

Any discussion of the prior art throughout the specification should in no way be considered as an admission that such prior art is widely known or forms part of common general knowledge in the field.

Backpacks are well known articles typically used as a means of carrying items needed for use in a variety of activities, including outdoor activities such as backpacking, hiking, camping, hunting, and the like. These outdoor activities, especially backpacking, can involve extended periods of strenuous upright physical exertion and therefore can be tiring. As such, it would be desirable to be able to sit and rest when engaged in such outdoor activities. Oftentimes, however, when engaged in these outdoor activities, a means on which to sit is not readily available and can only be afforded by whatever natural objects can be found, such as logs, rocks, etc. These means, however, provide limited comfort. The more comfortable and relaxing the means to sit, the more restful and enjoyable would be the outdoor experience, and hence the more desirable would be such a means. As such, it would be desirable if some easily transportable means to sit and rest were available so as to be useable during these outdoor activities. As well, it would be even more desirable if such means were also capable of providing a means to carry the items needed for the particular outdoor activity.

Therefore, as a need for such means exits, it can be appreciated that backpacks that can be converted into a chair or a seat (convertible backpacks) have been in use for years. These convertible backpacks are intended to provide the functionality of a backpack of adequate comfort, capacity, and utility, as well as the functionality of a chair or seat. Typically, these convertible backpacks are comprised of a lightweight metal alloy, plastic, or wood frame, fabric or hard shell cargo compartments that are either fixedly or detachably attached by some means to the frame, fabric seat and back panels, shoulder straps, and in some designs a hip belt. To be able to sit using these convertible backpacks, they generally require that the backpack be removed by the wearer, and then through some conversion process, be converted to provide the use of a chair or seat.

Several proposals to accomplish the purposes set forth above have been proposed in the art, but they have various deficiencies:

In some designs (see: U.S. Pat. No. 3,266,686; U.S. Pat. No. 3,912,138; U.S. Pat. No. 4,450,990) the conversion from backpack to chair is cumbersome due to the need to disassemble and reassemble parts, undo clevis pins, insert tubes into other tubes etc. The conversion to and from backpack to chair can be a cumbersome, and confusing process.

In some designs (see: U.S. Pat. No. 5,297,708; U.S. Pat. No. 5,318,342; U.S. Pat. No. 5,544,793; U.S. Pat. No. 5,409,291) the frame is simply a conventional folding patio chair with a means to mount cargo compartments to the frame, a pair of shoulder straps, and sometimes a hip belt. These types of designs provide a fairly comfortable chair, but fail to provide an adequate backpack, as a folding chair is not generally intended or well adapted to function as a backpack frame and hence lacks the comfort and functionality of a dedicated backpack frame. These types of designs tend to include small, insufficient cargo compartments, and the various cross tubes inherent in folding patio chairs tend to protrude against the wearer's back resulting in discomfort.

Other designs (see: U.S. Pat. No. 4,387,924; U.S. Pat. No. 5,597,101; U.S. Pat. No. 5,927,798) use a typical scissor-frame or X-frame chair for the backpack frame. These types of designs suffer from the same problem as the folding chair designs in that they use adapted chair frames that do not make very adequate backpack frames. In these designs, the means for sitting usually provides a small seating area and, oftentimes, no back, resulting in limited comfort. In the designs that do offer a back, the back usually does not recline, does not support the full length of the back, and usually does not offer a headrest. The seat in these designs is only adequate for sitting upright, not for reclining back in a more comfortable relaxed position.

Still other designs (see: U.S. Pat. No. 3,250,449; U.S. Pat. No. 3,822,422; U.S. Pat. No. 3,912,138; U.S. Pat. No. 4,286,739) attempt to extend the role of the frame to go beyond a backpack and a chair so as to include the role of a cot and/or a tent as well. These types of designs tend to be heavy, cumbersome, and difficult to convert between their various roles, and tend to become a “jack-of-all-trades, master-of-none.”

While these devices may be suitable for the particular purpose to which they address, they are not as suitable for providing a fully functional backpack frame that converts into a comfortable chair. The designs set forth above illustrate the main problem with convertible backpacks, namely they do not adequately perform the role of backpack and the role of chair. They may provide an adequate means to carry equipment, but are poor at providing a means to sit and rest or relax comfortably, or vice versa. In trying to satisfy the requirements of the two (or more) roles, they compromise the functionality of one, or the other, or both, and, as a result, the backpack, or the chair, or both, are less than satisfactory. Other disadvantages and problems with previous designs of convertible backpacks include:

Some maintain the back of the chair at a fixed angle relative to the seat of the chair, thereby limiting the range of comfort afforded by the chair. In these designs, the back of the chair does not recline and a person can only sit with their back in one position—usually upright.

Some provide a chair whose seat is close to the ground and/or at an inclined angle whereby the front of the seat is higher off the ground than the back of the seat. These configurations require the person sitting in the chair to either extend their legs outward or have their knees bent excessively upward toward their chest. Sitting in either of these postures puts excessive pressure on the posterior of the person and results in discomfort when sitting for extended periods of time. Some even have chairs with no legs whereby the seat rests on the ground, making it even more uncomfortable to sit.

Some do not provide a headrest for the back of the chair. A headrest greatly increases the comfort afforded by the chair by allowing one to lean back with their head supported.

Some have a headrest at a fixed position on the chair's back, which may only comfortably accommodate a narrow range of torso sizes. People with torsos outside this size range may not be able to sit and lean back comfortably.

Some provide a headrest for the back of the chair, but as a separate dedicated headrest that adds weight, bulkiness, and cost to the convertible backpack.

Some require the adjustment of the relative vertical position between the hip belt and the backpack frame be adjusted for fit while the backpack is not being worn. In these designs, adjusting the fit of the backpack is a trial and error process whereby the person removes the backpack, adjusts the backpack, and then tries it back on for fit, repeating these steps until a good fit is achieved. Then, if while in use—after the proper fit is achieved, the loads in the backpack change or shift, or the fit of the backpack, for whatever reason, no longer feels right, the backpack must be removed to readjust the fit. U.S. Pat. No. 5,284,279 does address this problem, but it moves the shoulder straps instead of the hip belt, and it uses a complicated mechanism that is heavy and expensive to manufacture.

Some have cargo compartments that are not detachable from the backpack, remaining mounted to the frame even after the backpack has been converted to a chair. In these designs, it is difficult to move the chair about when one wishes to sit in a different location, such as when one location becomes too sunny and hot. Unless the cargo compartments are emptied (a potentially burdensome process in itself), the weight of their contents (e.g. cloths, food, equipment, and the like) can be substantial, and must be moved along with the chair, thus making it cumbersome and difficult to move the chair. Also, access to the contents of the cargo compartments may be impeded when the backpack is converted to a chair, and if no one is seated in the chair, the contents of the compartments may make the chair unstable to the point of overturning.

Therefore, it will be appreciated from the foregoing that there is a need for a convertible backpack frame that is fully functional, yet simple and lightweight, that can be easily and quickly be converted to a comfortable reclinable chair with an adjustable headrest, for sitting upright as well as reclining back, and that excels at both the role of backpack and of chair. The present invention fulfills this need.

In these respects, the convertible backpack frame according to the present invention substantially departs from the conventional concepts and designs of the prior art, and in so doing, provides an apparatus primarily developed for the purpose of providing a backpack frame that converts into a reclinable chair with an adjustable headrest.

### SUMMARY OF THE INVENTION

In view of the foregoing disadvantages inherent in the known types of convertible backpack frames now present in the prior art, the present invention provides a new convertible backpack frame construction wherein the same can be utilized for use as a backpack frame or a reclinable chair with an adjustable headrest.

The general purpose of the present invention, which will be described subsequently in greater detail, is to provide a new convertible backpack frame that has many of the advantages of the convertible backpack frame devices mentioned heretofore and many novel features that result in a new convertible backpack frame which is not anticipated, rendered obvious, suggested, or even implied by any of the prior art convertible backpack frame devices, either alone or in any combination thereof.

Note that in the case of backpacking, a person is usually away from civilization and modern conveniences for a number of days and needs to be self-sufficient. As such, a substantial amount of supplies such as food, clothing, a sleeping bag and pad, shelter, etc., all of which must be carried, is needed. In order to carry such an amount of supplies, a backpack of adequate capacity must be used, in which case small rucksacks and the like would not be suitable. The present invention is optimally adapted for the needs of a backpacker, and therefore is adapted to such size so as to have a carrying capacity suitable for backpacking. However, although it is optimized for backpacking, it may still be adapted for and used in any circumstance that calls for a backpack.

To attain the purpose of the present invention, one embodiment of the present invention includes a convertible backpack frame usable in a first mode as a backpack frame and usable in a second mode as a chair having a reclinable backrest and an adjustable headrest, such convertible backpack frame comprising a frame assembly, a seat assembly, a backrest assembly, a hip belt assembly, and a plurality of shoulder strap assemblies.

The frame assembly includes an upper frame member, a lower frame member, and a plurality of locking telescoping members. The upper frame member, which provides the upper structure of the backpack frame in the first mode, and the seat supports and legs of the chair in the second mode, includes a U-shaped first section with parallel lateral sides having a V-shape bend formed in each lateral side forming vertical side portions and a rearward-extending lower portion, a U-shaped second section joined substantially perpendicular and proximate to the upper ends of the first section, and an optional crossbar member joined transversely between and proximate to the ends of the second section. The lower frame member, which provides the lower structure and backrest of the backpack frame in the first mode and the backrest of the chair in the second mode, includes a substantially rectangular section, and an optional crossbar member joined transversely between the lateral sides proximate the upper end of the rectangular section. The upper frame member and the lower frame member are pivotably coupled about a transverse axis, allowing them to pivot between their first and second mode orientations. Each telescoping member includes an inner section and an outer section, slidably coupled to each other, and a locking apparatus adapted to control relative sliding between the inner and outer sections. A telescoping member is disposed at each lateral side of the frame assembly, and maintains the orientation of the upper frame member with respect to the lower frame member.

The seat assembly includes a flexible sheet attached to the upper lateral sides of the U-shaped first section to provide a sitting surface in the second mode. The backrest assembly includes a flexible sheet that is attached to the lower frame member to provide a taught surface for the backrest of the backpack frame and the chair. The hip belt assembly includes a hip pad, support straps, a suspension strap, and a headrest support apparatus, and provides a hip support for the backpack frame in the first mode, and the headrest of the chair in the second mode. The support straps are joined to the backside of the hip pad and coupled to the lower frame member, so as to transfer the load of the backpack frame to the hip pad, as well as permit adjustment of the relative position of the hip pad to the backpack frame, in the first mode. The suspension strap is joined to the hip pad and to the lower frame member, and maintains the hip belt assembly in an upright suspended position in the first mode. The headrest support apparatus includes a plurality of support arms that are attached to the hip belt, and that, in the second mode, are adapted to extend outwardly from the hip belt to provide supports that are engaged to the lower end of the lower frame member adapted to receive the support arms. Each shoulder strap assembly provides shoulder support in the first mode, and includes a shoulder pad attached to the upper end of the lower frame member and an adjustment strap attached to the hip pad.

In use, the convertible backpack frame, in the first mode as a backpack frame, is worn in a conventional manner and may be adjusted for fit by adjusting the support straps on either lateral side of the hip belt. The convertible backpack frame is converted into the second mode by unlocking the locking telescoping members, rotating the orientation of the lower frame member with respect to the upper frame member to that of a chair, relocking the telescoping members, and then repositioning the hip belt assembly to its position, as the headrest, at the lower end of the lower frame member.

There has thus been outlined, rather broadly, the more important features of the invention in order that the detailed description thereof may be better understood and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a convertible backpack frame that will overcome the shortcomings of the prior art devices. Accordingly, several objects and advantages of the present invention are:

(a) to provide a convertible backpack frame that is usable as a backpack frame or a chair having a reclinable backrest and an adjustable headrest.

(b) to provide a convertible backpack frame whereby the process of converting the backpack frame to and from a reclinable chair is a simple process that requires no tools, or assembly or disassembly of parts.

(c) to provide a convertible backpack frame whereby the backrest of the backpack frame has no protruding supports that would interfere with or be uncomfortable to the wearer.

(d) to provide a convertible backpack frame whereby the backrest of the chair supports the full length of the sitter's back and can recline to any of a plurality of positions from upright to fully laid back.

(e) to provide a convertible backpack frame whereby the seat of the chair is at a comfortable incline and height above the ground.

(f) to provide a convertible backpack frame whereby the hip belt of the backpack also provides the headrest of the chair, thereby eliminating the extra components, weight, and cost of a dedicated headrest.

(g) to provide a convertible backpack frame, whereby the height of the headrest of the chair can be adjusted to accommodate a range of torso sizes.

(h) to provide a convertible backpack frame whereby the vertical position of the hip pad with respect to the backpack frame is adjustable by the wearer, even while the backpack frame is being worn.

(i) to provide a convertible backpack frame whereby the frame is a separate component from any cargo compartments and functions as a backpack frame or a reclinable chair independently of any cargo compartments.

(j) to provide a convertible backpack frame whereby the cargo compartments provide adequate capacity for the needs of backpacking and may be detachably attached, easily and securely, to the backpack frame, thus providing improved flexibility and access to the compartments and their contents, and allowing the chair to be moved about without the burden of attached compartments.

(k) to provide a convertible backpack frame that is economical to manufacture, durable in use, and refined in appearance.

Other objects and advantages of the invention will become obvious to the reader and it is intended that these objects and advantages are within the scope of the invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of embodiments of the invention will become fully appreciated as the same becomes better understood when considered in conjunction with the accompanying drawings, in which like reference characters designate the same or similar parts throughout the several views, closely related figures have the same number but different alphabetic suffixes, the distinctions between figures with different alphabetic suffixes are readily comprehended, and wherein:

FIG. 1 shows a front perspective view of the convertible backpack frame, in the first mode, as a backpack frame.

FIG. 2 shows a rear perspective view of the convertible backpack frame, in the first mode, as a backpack frame.

FIG. 3 shows a side plan view of the convertible backpack frame, in the first mode, as a backpack frame worn by a person.

FIG. 4 shows a front perspective view of the convertible backpack frame, in the second mode, as a chair.

FIG. 5 shows a rear perspective view of the convertible backpack frame, in the second mode, as a chair.

FIGS. 6A and 6B show side plan views of the convertible backpack frame, in the second mode, as a chair being sat in by the person, with the backrest at two different angles of recline, respectively.

FIG. 7 shows a partially exploded rear perspective view of the frame assembly oriented, as it would be in the first mode, as a backpack frame.

FIG. 8 shows a front perspective view of the frame assembly oriented, as it would be in the second mode, as a chair.

FIGS. 9A and 9B show forward and rear plan views, respectively, of the frame assembly.

FIGS. 10A to 10C show rear, side, and upper plan views, respectively, of the upper frame member.

FIGS. 11A and 11B show exploded rear and side plan views, respectively, of the lower frame member.

FIG. 11C shows an upper plan view of the lower frame member.

FIGS. 12A and 12B show side plan views, ninety degrees apart, respectively, of the outer section of a telescoping member.

FIGS. 13A and 13B show side plan views, ninety degrees apart, respectively, of the inner section of a telescoping member.

FIG. 14 shows an exploded perspective view of the inner section and outer section of a telescoping member.

FIGS. 15A and 15B show fragmented side sectional views of FIG. 12A along line 15A-15A and FIG. 13A along line 15B-15B, respectively.

FIG. 16 shows a fragmented perspective view of a telescoping member showing a locking apparatus in its locked state.

FIG. 17 shows fragmented perspective view of the open joint end of the outer section showing the slot in the outer section.

FIGS. 18A and 18B show fragmented upper plan views of FIG. 16 with a locking apparatus in its unlocked state and in its locked state, respectively.

FIGS. 19A and 19B show sectional views of FIG. 18A along line 19A-19A and of FIG. 18B along line 19B-19B, respectively.

FIG. 20A shows a facing plan view of the sheet used to construct the seat assembly.

FIG. 20B shows an upper plan view of the seat assembly mounted to the upper frame member oriented as it would be in the second mode.

FIG. 21 shows a forward facing plan view of the backrest assembly, alone, dismounted from the frame assembly.

FIG. 22 shows a perspective view of a backrest hook.

FIGS. 23A and 23B show fragmented sectional views of FIG. 2 along lines 23A-23A and 23B-23B, respectively.

FIG. 24 shows a fragmented sectional view of FIG. 5 along line 24-24.

FIGS. 25A and 25B show rear plan views of the hip belt assembly at a high and low position, respectively, relative to the lower frame member (shown in outline).

FIG. 26 shows a perspective view of a suspension hook.

FIG. 27A shows a fragmented rear plan view of the hip belt assembly showing the headrest support apparatus, oriented as it would be in the first mode, with support arms retracted.

FIG. 27B shows a fragmented rear plan view of the hip belt assembly showing the headrest support apparatus, oriented as it would be in the second mode, with support arms extended and engaged to the backrest of the chair.

FIGS. 28 and 29 show fragmented sectional views of FIG. 27A along line 28-28 and line 29-29, respectively.

FIG. 30A shows a fragmented sectional view of the hip belt assembly of FIG. 27B along line 29-29 showing the stop ring at various positions along the support arm.

FIGS. 30B and 30C show fragmented sectional views of the hip belt assembly of FIG. 27B along line 30-30 showing the headrest adjusted to a low and high position, respectively.

FIG. 31A and 31B show fragmented side plan views of the chair showing the headrest adjusted to a low and high position, respectively.

FIG. 32 shows a front perspective view of a convertible backpack frame, in the first mode, as a backpack frame.

FIG. 33 shows a front perspective view of a convertible backpack frame, in the second mode, as a chair.

FIGS. 34A and 34B show fragmented side sectional views of FIG. 32 along lines 34A-34A and 34B-34B, respectively.

FIG. 35 shows a rear perspective view of a convertible backpack frame, in the first mode, having detachably attached cargo compartments.

FIG. 36 shows a rear perspective view of the convertible backpack frame of FIG. 35 (with upper compartment detached) showing the lower compartments attachment to the backpack frame.

FIG. 37 shows a fragmented side sectional view of FIG. 36 along line 37-37.

FIG. 38 shows a fragmented side sectional view of FIG. 35 along line 38-38.

FIGS. 39A and 39B show front and rear plan views, respectively, of an upper forward corner of a cargo compartment.

FIG. 40 shows a fragmented front plan view of the upper corner of a cargo compartment attached to the upper frame member.

FIG. 41 shows a fragmented side sectional view of FIG. 40 along line 41-41.

FIG. 42 shows a fragmented side sectional view of FIG. 35 along line 42-42.

FIG. 43 shows a fragmented side sectional view of FIG. 35 along line 43-43.

FIG. 44 shows a fragmented rear perspective view of a convertible backpack frame, in the first mode, with separate, detachably attached, side cargo compartments.

FIGS. 45A and 45B, show side perspective views, ninety degrees apart, respectively, of the side cargo compartment from FIG. 44.

FIG. 46 shows an enlarged view of FIG. 44 indicated by circle 46.

FIG. 47 shows a fragmented side sectional view of FIG. 44 along line 47-47.

FIG. 48 shows a fragmented rear perspective view of a convertible backpack frame, in the first mode, with separate, detachably attached, side cargo compartments

FIG. 49 shows a side perspective view of a side cargo compartment from FIG. 48.

FIG. 50 shows a fragmented side sectional view of FIG. 48 along line 50-50

FIG. 51 shows a rear perspective view of a cargo compartment.

FIG. 52 shows an exploded perspective view of an attachment pin.

FIG. 53A shows a perspective view of an attachment pin.

FIG. 53B shows a side sectional view of FIG. 53A along line 53B-53B.

FIGS. 54A and 54B show a perspective view of an attachment tab and a top plan view of an attachment tab engaged to an attachment pin, respectively.

FIG. 55 shows a top plan view of an attachment tab engaged to an attachment pin.

FIG. 56A shows a perspective view of a latch tab.

FIG. 56B shows a side sectional view of FIG. 56A along line 56B-56B.

FIGS. 57A to 57E show fragments side sectional views of the steps of operation of latching and unlatching a latch tab.

FIG. 58 shows a rear perspective view of a frame assembly attached together by fittings.

FIG. 59 shows a rear perspective view of a frame fitting.

FIGS. 60A and 60B show fragmented side and upper plan views, respectively, of a frame fitting with frame sections attached by it.

FIG. 61 shows a rear perspective view of a frame fitting.

FIGS. 62A and 62B show fragmented rear and upper plan views, respectively, of a frame fitting with frame sections attached by it.

FIGS. 63A and 63B show perspective and exploded perspective views, respectively, of a tubular telescoping member.

FIG. 64 shows a perspective view of a locking apparatus from FIGS. 63A and 63B.

FIG. 65A shows a fragmented side sectional view of FIG. 63A along line 65A-65A.

FIG. 65B shows the view of FIG. 65A with the locking apparatus and telescoping member in an unlocked state.

FIG. 66A shows an exploded rear perspective view of a U-shaped first section, having multiple sections.

FIG. 66B shows a sectional view of FIG. 66A along line 66B-66B.

FIGS. 67A and 67B show upper and lower plan views, respectively, of an upper frame member.

FIG. 68 shows rear a perspective view of a lower frame member.

FIG. 69 shows a perspective view of a headrest support apparatus.

FIG. 70 shows an enlarged view of FIG. 69 indicated by circle 70.

FIG. 71 shows a perspective view of a headrest support apparatus.

FIG. 72 shows an enlarged view of FIG. 71 indicated by circle 72.

FIG. 73 shows a rear perspective view of a headrest support apparatus, oriented as it would be in the second mode, having support arms attached to the lower frame member.

FIG. 74A shows a fragmented rear perspective view of the lower frame member, oriented as it would be in the first mode as a backpack frame, with the support arms pivoted to their first mode orientation.

FIG. 74B shows a fragmented rear perspective view of a lower frame member, oriented as it would be in the first mode, showing holes adapted to receive the pins of the support arm apparatuses.

FIG. 75 shows a side sectional view of FIG. 74B along line 75-75.

FIGS. 76A and 76B show fragmented rear and upper plan views, respectively, of a support arm apparatus attached to the lower frame member, with the lower frame member oriented as it would be in the second mode as a chair frame, and showing the support arm in its first (shown in outline) and second mode orientation.

FIG. 77 shows a rear plan view of the hip belt assembly with coupling straps joined at an alternate position.

FIG. 78 shows a facing view of a sheet used to construct a seat assembly.

FIGS. 79A and 79B show upper plan and front perspective views, respectively, of a seat assembly mounted to the upper frame member.

FIG. 80A shows a front perspective view of the chair with shoulder straps repositioned to be hanging behind the chair, out of the way of the seat.

FIG. 80B shows a side plan view of the chair in FIG. 80A.

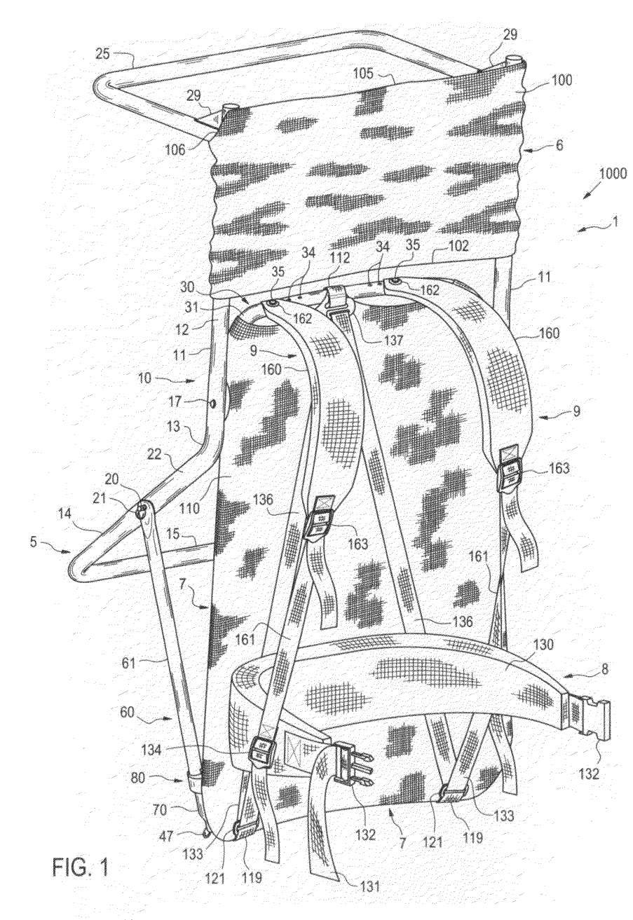

### DETAILED DESCRIPTION OF PREFERRED EMBODIMENT—FIGS. 1-31B

### A. Overview

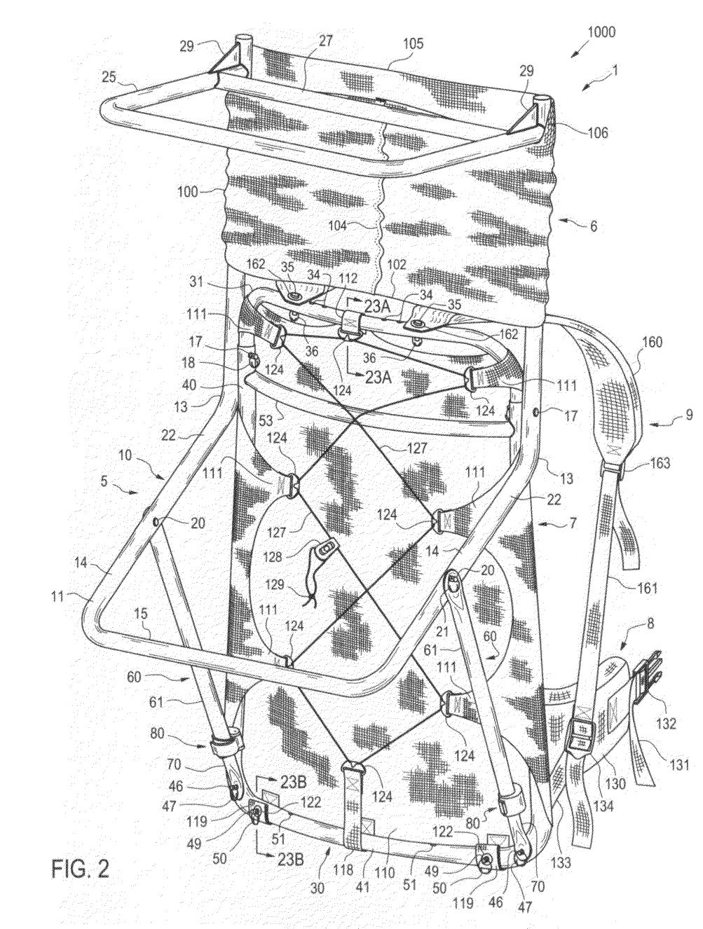

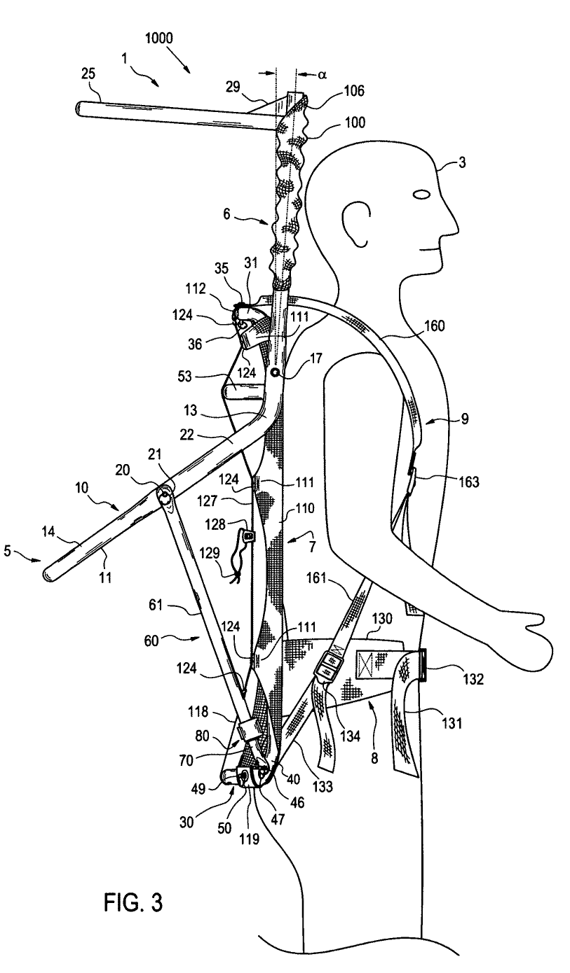

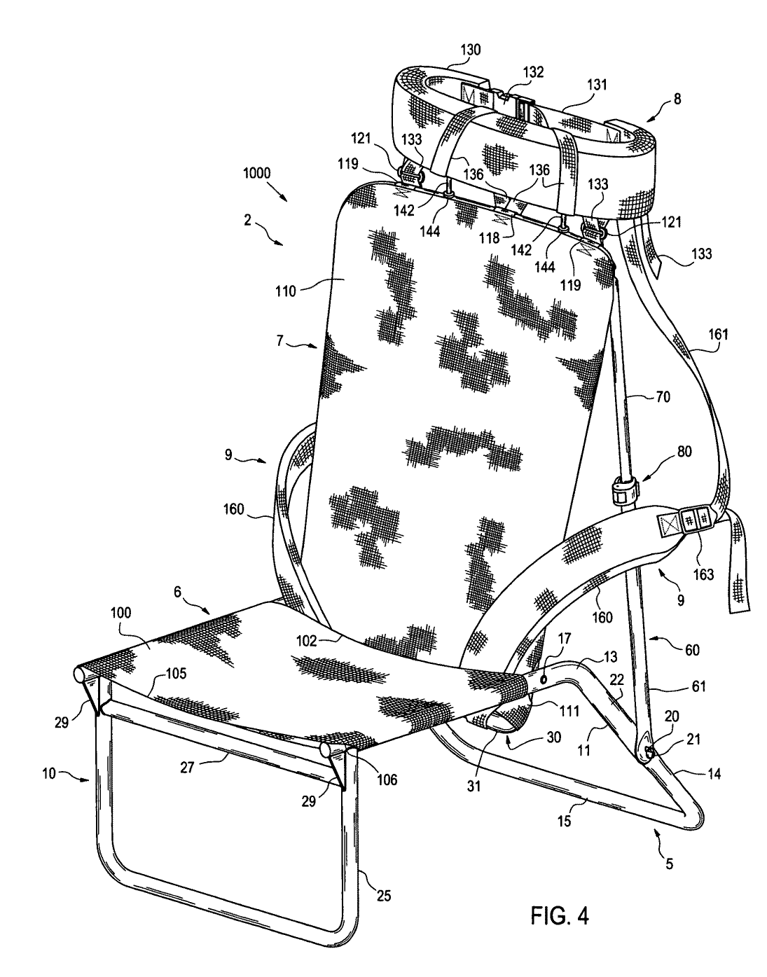

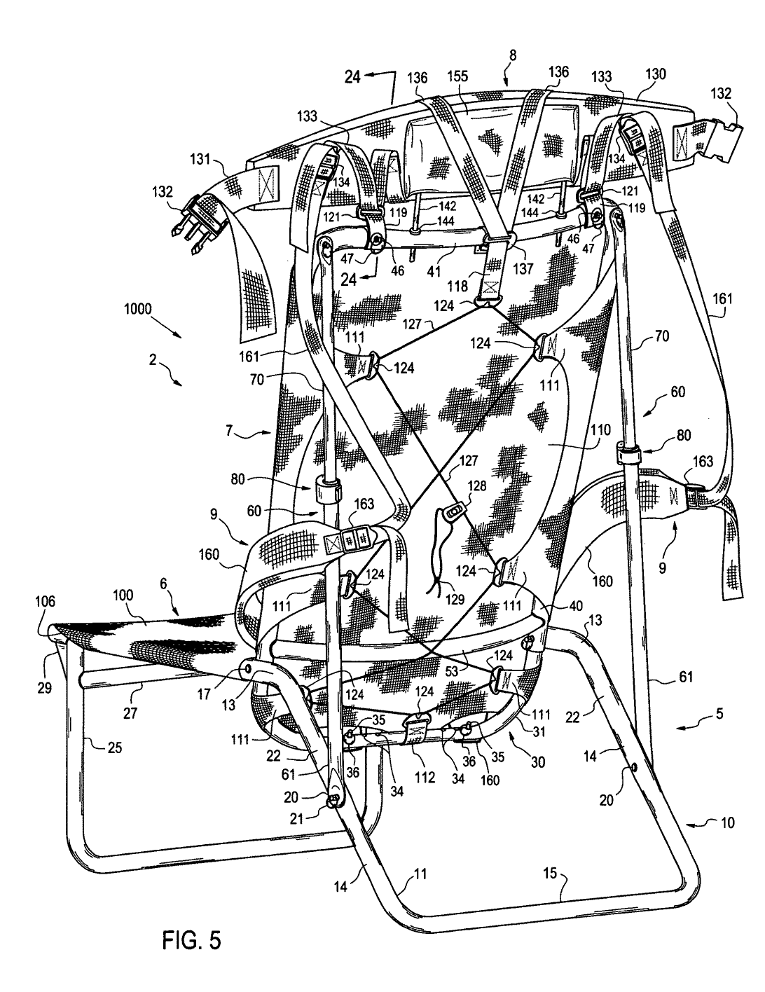

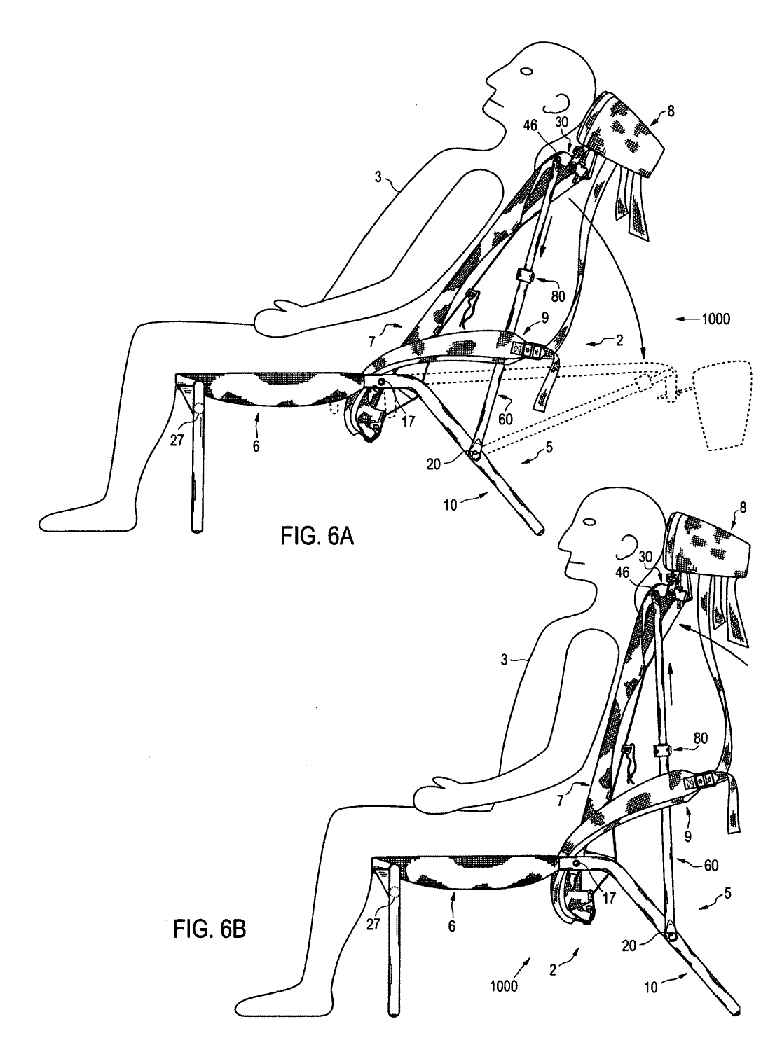

FIGS. 1 to 3 show a convertible backpack frame 1000 in a first mode as a backpack frame 1, where FIGS. 1 and 2 show front and rear perspective views, respectively, and FIG. 3 shows a side plan view with backpack frame 1 being worn by a person 3. FIGS. 4 to 6B show convertible backpack frame 1000 in a second mode as a chair 2, where FIGS. 4 and 5 show front and rear perspective views, respectively, and FIGS. 6A and 6B show side plan views of chair 2 with the backrest at a laid back and upright angle of recline, respectively, being sat in by person 3. Referring to FIGS. 1 to 6B, convertible backpack frame 1000 includes a frame assembly 5, a seat assembly 6, a backrest assembly 7, a hip belt assembly 8, and a plurality of shoulder strap assemblies 9.

### B. Frame Assembly

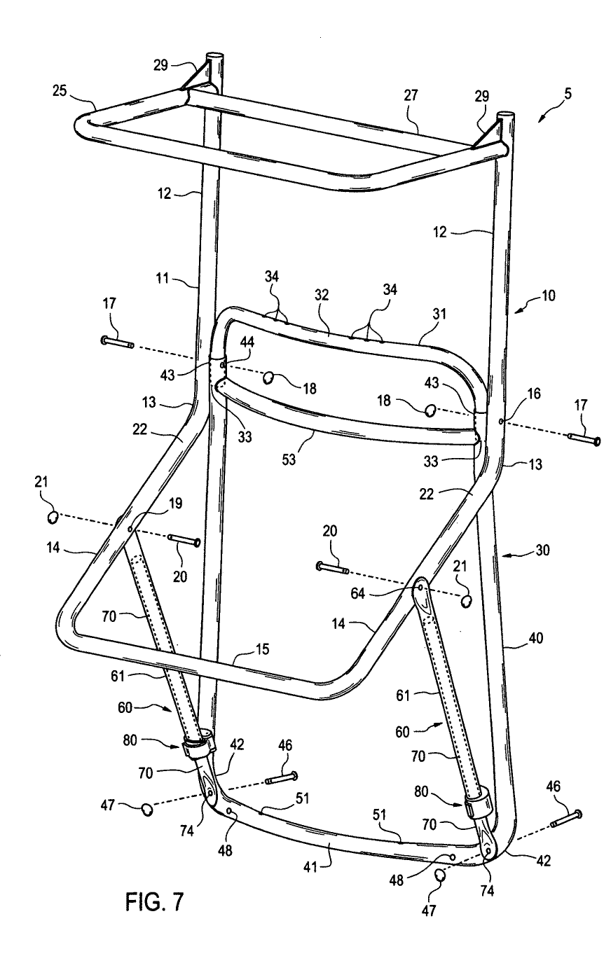

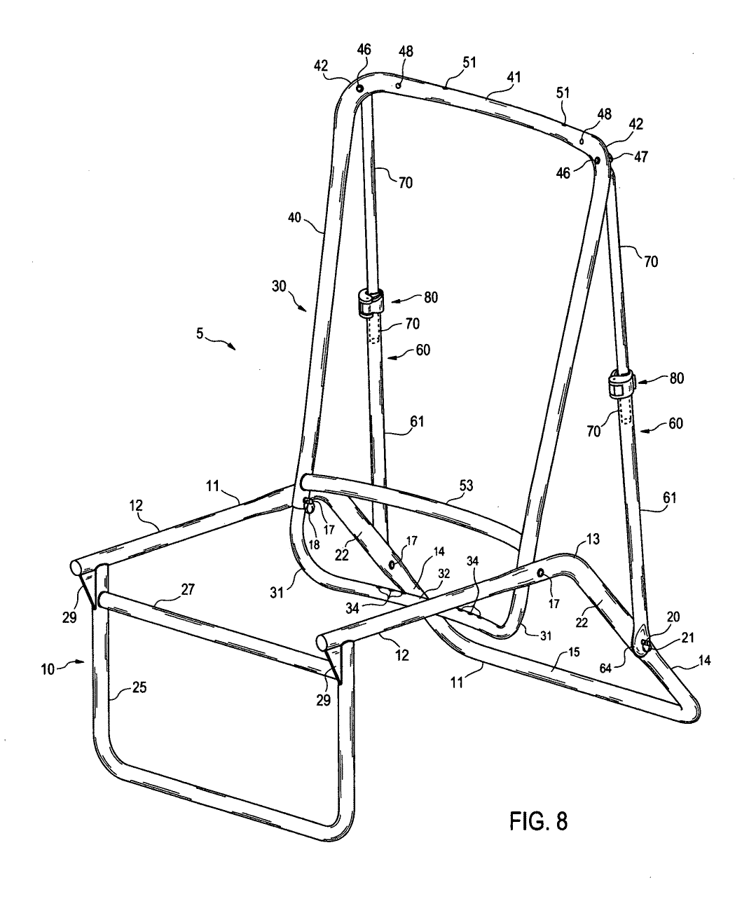

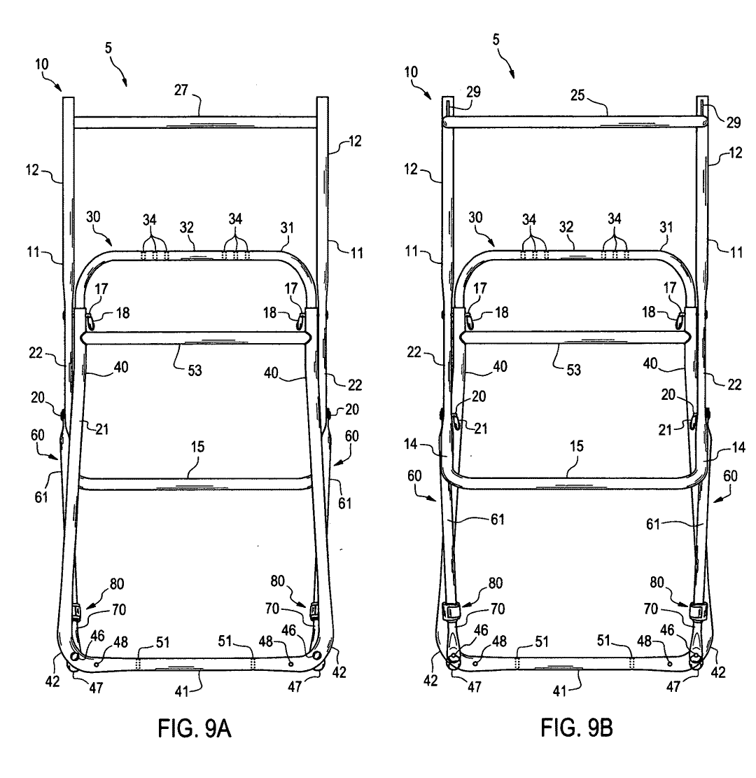

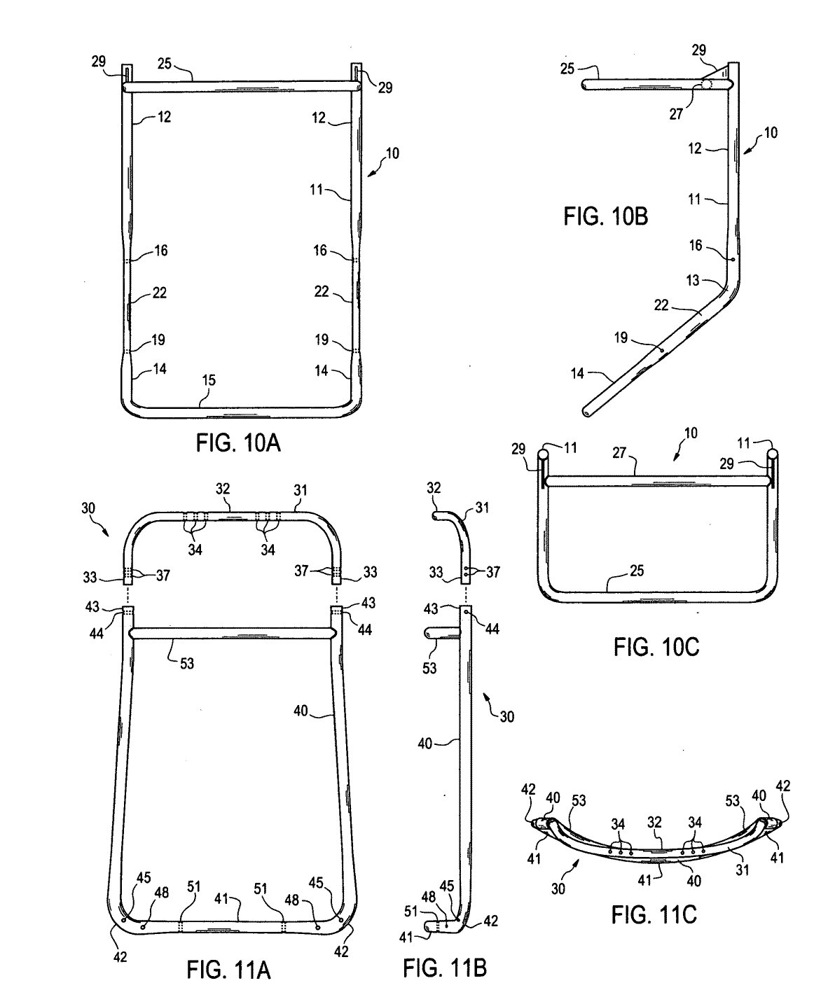

FIG. 7 shows a partially exploded rear perspective view of frame assembly 5, oriented as it would be, in the first mode, and FIG. 8 shows a front perspective view of frame assembly 5, oriented as it would be in the second mode. FIGS. 9A and 9B show forward and rear plan views, respectively, of frame assembly 5. FIGS. 10A to 10C show rear, side, and upper plan views, respectively, of upper frame member 10, with FIGS. 10A and 10B showing upper frame member 10 generally oriented as it would be in the first mode. Referring to FIGS. 7 to 10B, frame assembly 5 includes an upper frame member 10, a lower frame member 30, and a tubular telescoping member 60 disposed on each lateral side of frame assembly 5. Upper frame member 10 includes a U-shaped first section 11 with substantially parallel lateral sides (see FIG. 10A), and includes upwardly-extending side portions 12 and a rearward-extending lower portion 14 separated by V-shaped bends 13 (see FIG. 10B), and a horizontal portion 15. Upper frame member 10 also includes a rearward-extending U-shaped second section 25 whose free ends are joined substantially perpendicular and proximate to the free ends of side portions 12. A crossbar section 27 may be included and joined transversely between and proximate to the ends of second section 25 to provide a brace to help keep first section 11 and second section 25 from bending inwardly due to tension from seat assembly 6 resulting from the weight of person 3 sitting in chair 2. Crossbar section 27 is positioned a substantial distance from the ends of second section 25 so as to provide some space to allow for the legs of person 3 to extend out unimpeded when sitting in chair 2 (see FIGS. 6A and 6B). A gusset 29 may be joined at each lateral side of upper frame member 10 to strengthen the joints between first section 11 and second section 25. In the first mode, upper frame member 10 provides the upper structure of backpack frame 1 (see FIGS. 1 to 3), and in the second mode, the legs of chair 2 and the lateral side supports for seat assembly 6 (see FIGS. 4 to 6B). As best seen in FIGS. 6A and 6B, upper frame member 10 provides chair 2 with a seat that is at a comfortable height and incline off the ground. In one embodiment, the seat is at a level incline and a height of about 11 inches off the ground. Second section 25, in the first mode, also provides a convenient loading platform for articles such as tents, sleeping pads, sleeping bags, and the like. A transverse horizontal hole 16, adapted to receive a pin 17, secured by a pin retainer 18, is provided on both lateral sides of first section 11, disposed some distance up from bend 13, for pivotably coupling upper frame member 10 to lower frame member 30. A transverse horizontal hole 19, adapted to receive a pin 20, secured by a pin retainer 21, is provided on both lateral sides of first section 11, about halfway along lower portion 14, for pivotably attaching telescoping members 60 to upper frame member 10. Also, a portion 22 of first section 11 extending generally from hole 16 to hole 19, on both lateral sides of first section 11, may be flattened slightly (see FIGS. 10A and 10B) to add strength to bends 13 when, in the second mode as in FIGS. 6A and 6B, first section 11 must support the weight of person 3.

Referring to FIGS. 11A to 11C, which show rear, side, and upper plan views, respectively, of lower frame member 30, with FIGS. 11A and 11B showing lower frame member 30 exploded, and generally oriented as it would be in the first mode, lower frame member 30, having a substantially rectangular shape, includes an inverted U-shaped third section 31 and a U-shaped fourth section 40, having a horizontal portion 32 and 41, respectively, and open joint ends 33 and 43, respectively. A crossbar section 53 may be joined transversely between the lateral sides and proximate the upper end of fourth section 40 to add strength to lower frame member 30. In the first mode, lower frame member 30 provides the lower structure and backrest of backpack frame 1 (see FIGS. 1 to 3), and in the second mode, the backrest of chair 2 (see FIGS. 4 to 6B). Crossbar section 53 and horizontal portions 32 and 41 may be contoured rearwardly (see FIG. 11C) to allow for the curvature of the back of person 3 so that there are no protruding supports that would interfere with or be uncomfortable to the wearer. As best seen in FIG. 13A, the lower end of fourth section 40 may be somewhat wider than the upper end, giving it a substantially beaker-like shape, so as to better accommodate the width of the shoulders of person 3 when providing the backrest of chair 2 in the second mode. Also, as best seen in FIGS. 6A and 6B, lower frame member 30 supports the full length of the back of person 3. The bends forming the lower corners 42 of the fourth section 40 may be flattened slightly (see FIGS. 11A and 11B) to add strength and rigidity to lower frame member 30.

Referring especially to FIGS. 2, 7, 8, and 11A to 11C, one or more vertical holes 34, adapted to receive a pin 35, secured by a pin retainer 36, are provided on both lateral sides of horizontal portion 32 for attaching the upper end of a shoulder pad 160 to lower frame member 30. Multiple holes allow the lateral spacing of shoulder pads 160 to be adjusted to accommodate the shoulder width of person 3. Transverse horizontal holes 37 and 44, both adapted to receive pin 17, are provided proximate joint ends 33 and 43 on both lateral sides of third section 31 and fourth section 40, respectively. Also, as shown, there may be a plurality of holes 37 to allow for the vertical adjustment of third section 31 relative to fourth section 40, so as to provide for the changing of the relative vertical position that the upper end of shoulder strap assemblies 9 are attached to frame assembly 5, thus providing for better adjustment of the balance and fit of backpack frame 1 to the back of person 3. Joint ends 43 are adapted to slidably receive, by insertion, joint ends 33. When frame member 10 is pivotably coupled to frame member 30 via pin 17, hole 44 and one of holes 37 align coaxially, thus attaching together third section 31 and fourth section 40 forming frame member 30 as a single rigid unit. As such, the tubing of fourth section 40 may have a larger diameter to fit over the tubing of third section 31, with joint ends 43 and joint ends 33 parallel to each other so as to allow them to receive each other. Referring especially to FIG. 11A, a horizontal hole 45, adapted to receive a pin 46, secured by a pin retainer 47, is provided on both lateral sides of fourth section 40 for attachment of telescoping member 60 to lower frame member 30. A horizontal hole 48, adapted to receive a pin 49, secured by a pin retainer 50, is provided on both lateral sides of horizontal portion 41 for attachment of hip belt assembly 8 to lower frame member 30. A vertical hole 51, adapted to receive a tubular headrest support arm 142 (described below), is provided on both lateral sides of horizontal portion 41.

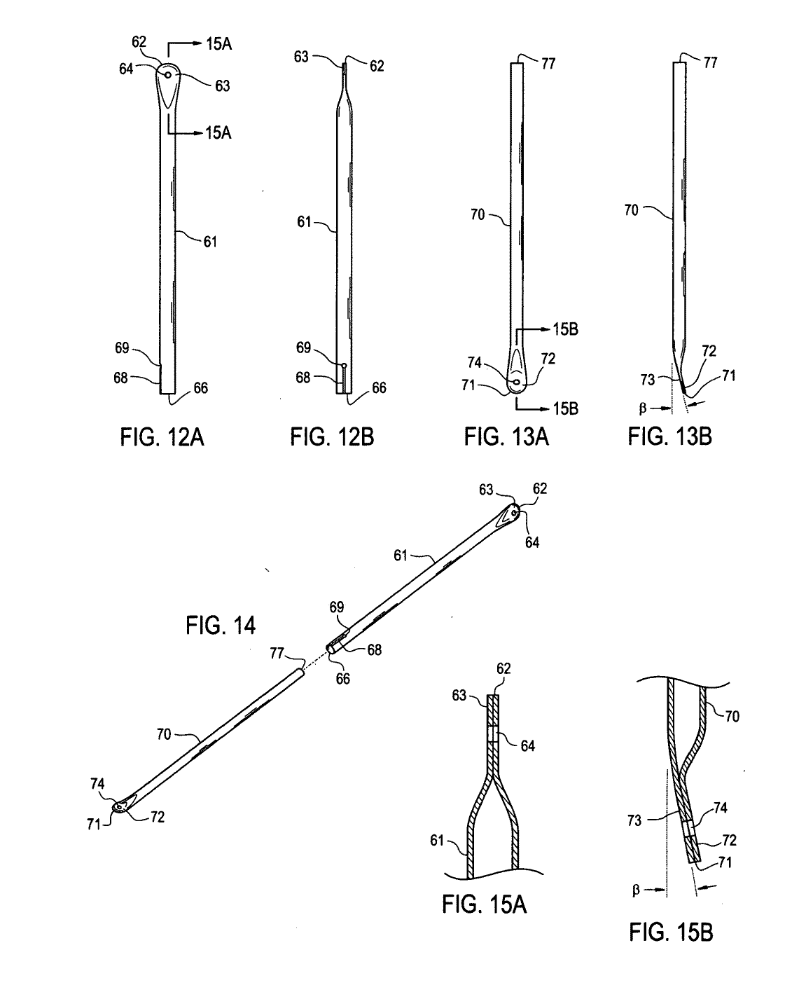

Referring to FIG. 7, each telescoping member 60 includes a tubular outer section 61, a tubular inner section 70, and a locking apparatus 80. FIGS. 12A and 12B show side plan views of outer section 61 with the views being ninety degrees from each other, respectively. FIGS. 13A and 13B show side plan views of inner section 70 with the views being ninety degrees from each other, respectively. Referring to FIGS. 12A to 13B, outer section 61 includes a closed end 62 adapted to be pivotably coupled to upper frame member 10, an open joint end 66 that is slidably coupled to inner section 70, and a gap or slot 68 (further described below). Inner section 70 includes a closed end 71 adapted to couple to lower frame member 30, and an open joint end 77 that is slidably coupled to outer section 61. Referring to FIG. 14, which shows an exploded view of inner section 70 and outer section 61, joint end 66 is adapted to receive joint end 77 to permit inner section 70 to slide into and out of outer section 61, thereby providing the telescoping action that allows telescoping member 60 to change length. As such, outer section 61 may have a larger diameter to fit over inner section 70. Outer section 61 and inner section 70 have approximately the same length, and being of such length such that telescoping member 60 can be extended to permit the backrest of chair 2 to be in an upright position such as in FIG. 6B, or be retracted to permit backrest to be in the first mode position as in FIG. 3. The lengths of outer section 61 and inner section 70 must also be such that when the backrest of chair 2 is in the maximum upright position at or near the maximum extension of telescoping member 60, there is an ample length of end 77 for end 66 to grasp on to so as to permit locking apparatus 80 to lock telescoping member 60 as well as enough to prevent lock telescoping member 60 from buckling. In one embodiment, outer section 61 and inner section 70 are each about 16½ inches in length.

FIGS. 15A and 15B show a side sectional view of FIG. 12A taken along line 15A-15A showing one end of outer section 61, and a side sectional view of FIG. 13A taken along line 15B-15B showing one end of inner section 70, respectively. Referring to FIGS. 15A and 15B, closed end 62 of outer section 61 may be flattened to form a flange 63 through which a hole 64 is bored substantially perpendicular to the plane of flange 63. Closed end 62 of outer section 61 is pivotably coupled to upper frame member 10 by way of pin 20 inserted through hole 64 and hole 19. Closed end 71 of inner section 70 may also be flattened to form a flange 72 through which a hole 74 is bored substantially perpendicular to the plane of flange 72. Flange 72 may be formed at an angle β so that the lower surface 73 of flange 72 will abut approximately flush when attached to lower frame member 30. Closed end 71 of inner section 70 is coupled to lower frame member 30 by way of pin 46 inserted through hole 74 and hole 45.

Referring to FIGS. 7 to 9B, lower frame member 30 is disposed between the lateral sides of upper frame member 10, such that the frame members are pivotably coupled to each other about an axis formed by pins 17 inserted through coaxial holes 16, 37, and 44, on both lateral sides of upper frame member 10, third section 31, and fourth section 40, respectively. Telescoping members 60 are coupled to upper frame member 10 and lower frame member 30 and control the orientation of upper frame member 10 with respect to lower frame member 30. As determined by the state of locking apparatus 80 (described below), telescoping members 60 may be in a locked state, whereby their length is kept fixed, or in an unlocked state, whereby their length may be changed. With telescoping members 60 in their locked state, the position of upper frame member 10 with respect to lower frame member 30, remain fixed, thereby maintaining frame assembly 5 as a strong and rigid unit (in either the first or second mode), by virtue of a triangular region of fixed points formed by pins 17, 20, and 46, on both lateral sides of frame assembly 5 (best seen in FIGS. 3, 6A, and 6B). With telescoping members 60 in their unlocked state, upper frame member 10 is free to pivot with respect to lower frame member 30, about the axis of pins 17, so that frame assembly 5 may be oriented in its first mode orientation (see FIGS. 1 to 3) or its second mode orientations (see FIGS. 4 to 6B). In one embodiment, the distances from pin 17 to pin 20, from pin 20 to pin 46, and from pin 46 to pin 17, are about 8, 15½, and 20½ inches, respectively. Telescoping members 60 provide a strong and lightweight mechanism that provides backpack frame 1 and chair 2 with sturdiness (due to the triangular region) and chair 2 a backrest that can recline to any of a plurality of positions from upright to fully laid back. FIGS. 6A and 6B show the backrest of chair 2 at two of a plurality of possible angles of recline, and as shown by the arrows, as upper frame member 10 and lower frame member 30 pivot about the axis of pins 17 (as shown by the curved arrows), telescoping members 60 retract and extend accordingly (as shown by the straight arrows). Also, in FIG. 6A, the maximum angle of recline of the backrest (shown in outline) would allow person 3 to lie fully back horizontally. Referring to FIG. 3, when in the first mode and telescoping members 60 may be retracted to their shortest length, upper frame member 10 may be oriented from lower frame member 30 at a small angle α so that frame assembly 5 more closely conforms to the curvature of the back of person 3.

In one embodiment, angle α may be in the range of about 5 to 7 degrees. In one embodiment, the tubular sections of frame assembly 5: first section 11, second section 25, crossbar section 27, third section 31, fourth section 40, crossbar section 53, inner section 70, and outer section 61, may be conveniently constructed from, for example, lightweight aluminum alloy tubing; the sections may be formed by, for example, bending and joined to each other by, for example, welding. Gussets 29 may be conveniently constructed from, for example, lightweight aluminum alloy and joined to first section 11 and second section 25 by, for example, welding.

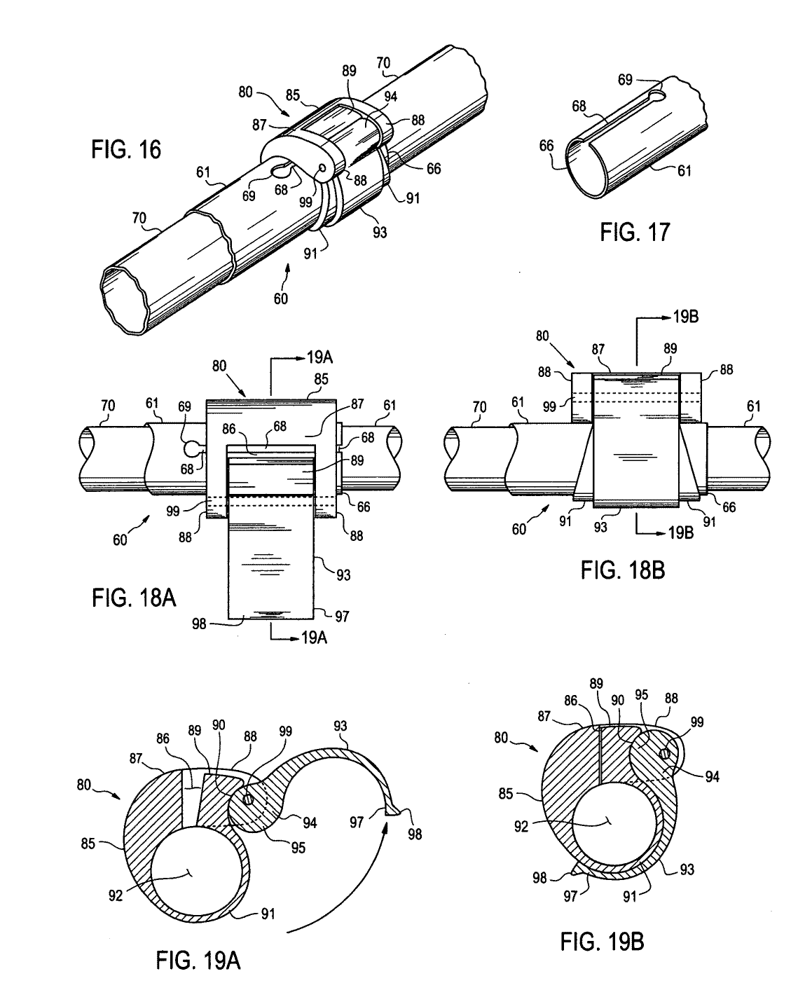

FIG. 16 shows a fragmented perspective view of telescoping member 60 with locking apparatus 80 in its locked state; FIG. 17 shows a fragmented perspective view of joint end 66 showing slot 68; and FIGS. 18A and 18B show fragmented upper and side plan views of FIG. 16, respectively, showing telescoping member 60 with locking apparatus 80 in its unlocked and locked state, respectively. Referring to FIGS. 16 to 18B, locking apparatus 80 is disposed about joint end 66 and provides control of the relative sliding between outer section 61 and inner section 70, and may be in a locked state, in which inner section 70 and outer section 61 are prevented from sliding relative to each other and the length of telescoping member 60 is kept fixed, or in an unlocked state, in which inner section 70 and outer section 61 are free to slide relative to each other and the length of telescoping member 60 can change. The locked and unlocked states of locking apparatus 80 correspond to the locked and unlocked states of telescoping member 60, respectively. Referring to FIGS. 16 and 17, slot 68, which extends from joint end 66 some distance toward closed end 62, allows squeezing of joint end 66 to reduce the circumference and diameter thereof so that it may frictionally grip inner section 70 to prevent relative sliding between outer section 61 and inner section 70. An enlarged area 69 may be provided at the closed end of slot 81 to relieve flexing stress and prevent cracking therein.

Referring to FIGS. 19A and 19B, which show sectional views of FIG. 18A along line 19A-19A and of FIG. 18B along line 19B-19B, respectively, locking apparatus 80 is formed by a clamp that includes a barrel-shaped tubular member 85 formed with an annular sidewall 91 which circumscribes a longitudinally extending central cylindrical bore 92 into which joint end 66 is inserted and frictionally held in place. Tubular member 85 is formed with a slot or gap 86 that extends the entire length of tubular member 85 to define facing or opposing sidewall edges 87 and 89 that are formed to be thicker than the rest of sidewall 91. Extending outwardly from the longitudinal ends of sidewall edge 87 are parallel arms 88. Formed on an exterior side of sidewall edge 89 is a camming surface 90, shaped to be slightly concave. Tubular member 85 may be constructed of resilient materials such as, for example, plastic, so that when a force is applied to camming surface 90, sidewall edge 89 is urged or biased toward sidewall edge 87, to narrow the width of gap 86 and reduce the diameter of central bore 92. This, in turn, allows for tightening of tubular member 85 about joint end 66 thereby causing it to grip inner section 70, and secure outer section 61 and inner section 70 in a fixed, non-slidable position. Locking apparatus 80 also includes a lever arm 93 pivotably attached between parallel arms 88 to pivot between an open position as shown in FIG. 19A, and a closed position as shown in FIG. 19B. The arrow in FIG. 19A indicates the pivoting motion of lever arm 93. The open and closed positions of lever arm 93 correspond to the unlocked and locked states, respectively, of locking apparatus 80. Pivot end 94 is pivotably attached between arms 88 by way of a pin 99 that bridges across the gap between arms 88. As seen in FIGS. 18A and 18B, lever arm 93 is wide enough to mostly fill the gap between arms 88.

Lever arm 93 includes a terminal end 97, and a pivot end 94 that is formed with a knuckle 95 disposed rearwardly and on the concave side of lever arm 93, so that when lever arm 93 is pivoted from the open position to the closed position, knuckle 95 cams on camming surface 90 to urge sidewall edge 89 toward sidewall edge 87 to narrow gap 86 and reduce the diameter of central cylindrical bore 92 and thereby tighten sidewall 91 about joint end 66 to cause it to grip inner section 70 and prevent relative sliding therebetween. Knuckle 95 is also formed so that as lever arm 93 is moved from the open position a certain distance toward the closed position, it snaps in a type of over-center snapping action to the closed position. Terminal end 97 is formed to present a blunt, tab-like surface 98 offset forwardly of barrel member 92 when lever arm 93 is in the closed position, to enable pushing against blunt surface 98 to move lever arm 93 from the closed position to the open position.

### C. Seat Assembly

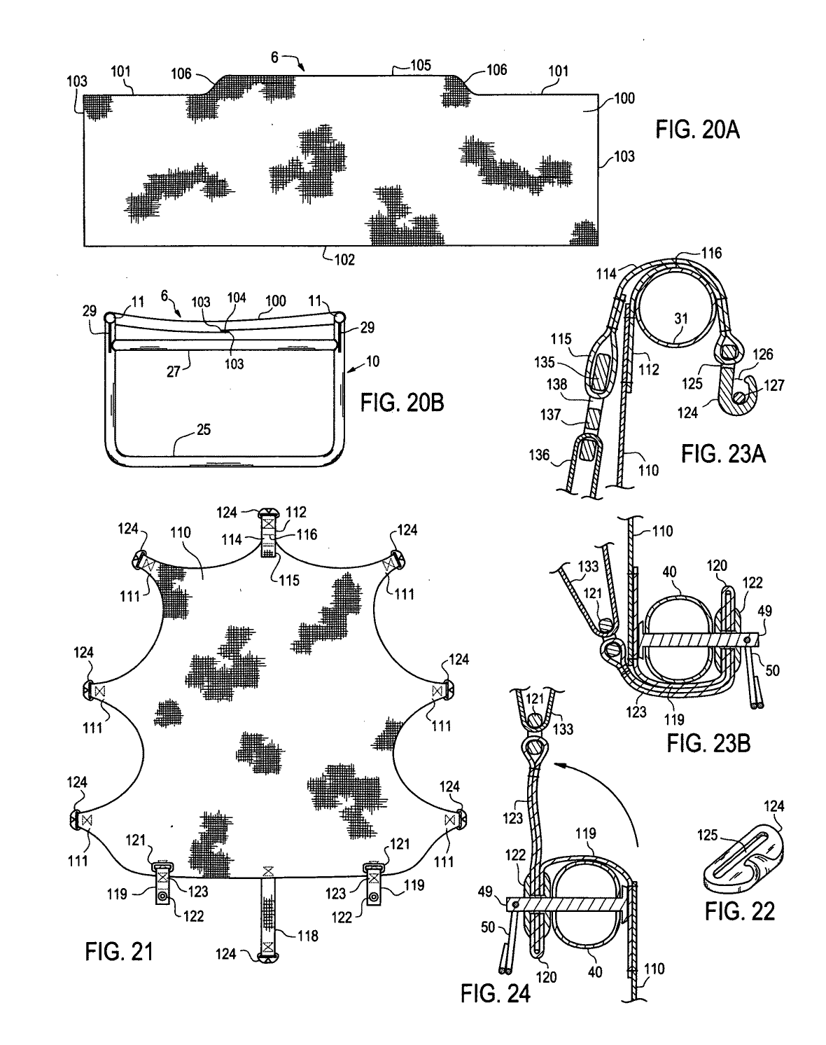

FIG. 20A shows a facing plan view of a substantially rectangular sheet 100 used to construct seat assembly 6. FIG. 20B shows an upper plan view of seat assembly 6 mounted to upper frame member 10. Referring to FIGS. 20A and 20B, sheet 100 has a forward edge 101, a rearward edge 102, lateral edges 103, and an extension 105 that extends out from the middle of forward edge 101, at a gradual taper 106, forming the forward edge of the seat of chair 2. Sheet 100 may be constructed from, for example, breathable stretch-resistant nylon mesh fabric, and is formed into a tube by joining lateral edges 103 together by, for example, stitching, thus forming a seam 104 (seen in FIG. 2). Seat assembly 6 is slipped over side portions 12, which provide the lateral support to maintain seat assembly 6 tensioned and in place as the seat of chair 2. Extension 105 increases the seating area by allowing forward edge 101 of seat assembly 6 to curve upward, forward, and around the tubes of side portions 12, extending the forward edge of seat assembly 6 beyond the joint where second section 25 is joined to first section 11, thus providing increased seating area. Optional extension 105 is partially free hanging and is not be completely supported by side portions 12, as is the interior of seat assembly 6. However, when person 3 sits on the seat, the lateral side pull of the fabric is transmitted to extension 105, by its gradual taper 106, and extension 105 becomes tensioned as the interior of seat assembly 6. Referring to FIGS. 4 to 6B, in the second mode, seat assembly 6 provides the seat of chair 2, becoming taught and tensioned, when person 3 sits in chair 2. Referring to FIGS. 1 to 3, seat assembly 6, in the first mode, provides no specific function, but is flexible enough and wrapped loosely enough around side portions 12 so that it can partially slide up and gather along side portions 12, to provide enough space for shoulder pads 160 to extend out from frame assembly 5 and over the shoulders of person 3.

### D: Backrest Assembly

FIG. 21 shows a forward facing plan view of backrest assembly 7 dismounted from lower frame member 30 and FIG. 22 is a perspective view of a hook 124. Referring to FIGS. 21, 22, and 2, backrest assembly 7 includes a sheet 110, formed mostly in the shape of the face of lower frame member 30, with one or more side extensions 111 on both of its lateral ends, an upper extension 112 at its upper end, a lower extension 118 at its lower end, and an attachment strap 119 on both lateral sides of its lower end. A hook 124 is attached at the end of each extension, by way of a slot 125 through which the end of the extension is passed, folded over, and stitched to itself. Sheet 110 may be constructed from, for example, breathable stretch-resistant nylon mesh fabric. Extensions 111 may be conveniently formed from and as part of the material of sheet 110, while extensions 112 and 118, and straps 119 may be constructed from, for example, nylon webbing, and joined to the rearward side of sheet 110 by, for example, stitching. Backrest assembly 7 also includes a lace cord 127 made from, for example, stretch-resistant cord material, and a conventional plastic lace lock 128. Hooks 124 may be made from, for example, molded plastic, or cast or stamped and bent lightweight metal alloy. Backrest assembly 7 provides the backrest surface for backpack frame 1 in the first mode (see FIGS. 1 to 3) and for chair 2 in the second mode (see FIGS. 4 to 6B).

Referring to FIGS. 21, 2, and 5, the rearward face of backrest assembly 7 is mounted to the forward side of lower frame member 30, and extensions 111, 112, and 118 are wrapped back around the outer edge of lower frame member 30 so as to grasp it (best seen in FIGS. 2 and 5). Sheet 110 is then made taught and held in place by tightening lace 127 that is laced, in a cross pattern similar to shoe laces, through hooks 124 at the end of extensions 111, 112, and 118. Lace 127 is held tight by lock 128, and prevented from slipping out of lock 128 by a knot 129. Lace 127 is laced such that the laces cross over the rearward side of crossbar section 53 (best seen in FIG. 2) to increase the tension on sheet 110 and provide somewhat of a barrier for the back of person 3 against any cargo compartments or cargo that may be attached to backpack frame 1. In both the first and second modes, backrest assembly 7 is kept taught to provide a smooth, non-sagging surface, with no protruding supports that would interfere with or be uncomfortable, for the back of person 3. Lace 127 may be retightened, when necessary, to compensate for any sag due to stretching or loosening that may result from normal use. The edges of sheet 110 between extensions 111, 112, and 118 may be contoured to better distribute the tension of lace 127 and provide a more uniform taughtness to sheet 110. Backrest assembly 7 remains mounted to lower frame member 30 in both the first and second modes. Also, extensions 111, 112, and 118, are positioned along the periphery of sheet 110 such that they tension sheet 110 evenly and do not interfere with the pivoting of upper frame member 10 and lower frame member 30.

FIGS. 23A and 23B show fragmented sectional views of backrest assembly 7, mounted to lower frame member 30, taken from FIG. 2 along lines 23A-23A and 23B-23B, respectively. FIG. 24 shows a fragmented sectional view of backrest assembly 7 taken from FIG. 5 along lines 24-24. Referring to FIG. 23A, the strap of extension 112 includes a portion 114 that extends forward from the loop that attaches to hook 124, and is folded over and stitched to form a loop 115 that provides an attachment point for hip belt assembly 8 by way of a suspension hook 137 having a hook portion 135 that is hooked into loop 115. Portion 114 may have an extra stitch 116 to help keep it oriented forward and to prevent it from flipping backward. The opening of loop 115 should be large enough to allow hook portion 135 to be easily inserted or removed. As seen in FIG. 23A, with backrest assembly 7 mounted to lower frame member 30, section 114 wraps itself forward over extension 112 extending out to the front side of backrest assembly 7. Each hook 124 has an entrance 126 that may be slightly smaller than the diameter of lace 127 that allows lace 127 to snap into hook 124, but prevents lace 127 from falling out of hook 124 when not tensioned, which may simplify the lacing of lace cord 127 to hooks 124. Referring to FIG. 23B, each strap 119, from the end joined to sheet 110, extends rearwardly, adjacent fourth section 40, to a fold 120 that folds forward to form strap section 123 that extends out to a loop, to which is attached ring 121, and then back rearwardly to in-between the inner facing sides of fold 120. A grommet 122 is joined to the strap through the three layers of strap at fold 120. Backrest assembly 7 is anchored to lower frame member 30 by straps 119 attached by way of pins 49 passing through grommets 122 and through holes 48, respectively. Each ring 121 provides an attachment point for hip belt assembly 8 to frame assembly 5 by way of strap 119, grommet 122, and pin 49. As shown by the arrow in FIG. 24, when in the second mode, section 123, being flexible, flaps upwardly to allow hip belt assembly 8 to be repositioned to provide a headrest for chair 2 (described below). Also, in FIGS. 23B and 24, the flattening near the corners 42 of fourth section 40 can be seen.

### E: Hip Belt Assembly

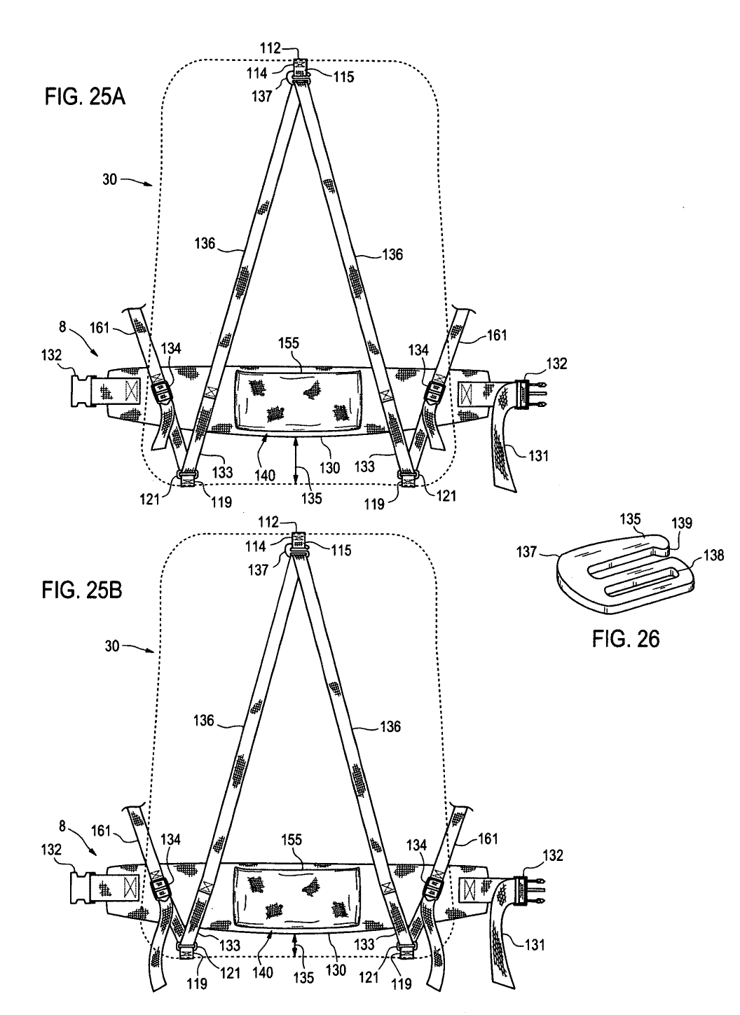

FIGS. 25A and 25B show rear plan view of hip belt assembly 8, oriented as it would be in the first mode, adjusted to a high and a low vertical position, respectively, relative to lower frame member 30 (shown in outline); also, hip pad 130 is not cinched for clarity. FIG. 26 shows a perspective view of hook 137. Referring to FIGS. 25A, 25B, and 26, hip belt assembly 8 includes a conventional hip pad 130 with a cinch strap 131 and a cinch buckle 132, a plurality of coupling straps 133, a suspension strap 136, and a headrest support apparatus 140 disposed substantially in the center of the rearward side of hip pad 130. In the first mode, hip belt assembly 8 provides hip support for backpack frame 1, as that of a conventional hip belt (see FIGS. 1 and 3). In the second mode, hip belt assembly 8 provides the headrest of chair 2, with hip pad 130 providing the surface against which the head of person 3 rests (see FIGS. 4, 6A and 6B). Thus by combining the functionality of a hip belt and a headrest, hip belt assembly 8 eliminates the extra components, weight, and cost of a dedicated headrest.

Coupling straps 133 are joined to both lateral sides, respectively, of the rearward side of hip pad 130, threaded forward through ring 121, and then upward through an adjustable buckle 134. Buckle 134 may be joined to hip pad 130 by way of the lower end of a support strap 161 (described below as part of shoulder strap assembly 9). Coupling straps 133 couple hip belt assembly 8 to frame assembly 5 by way of rings 121 and straps 119. In the second mode, coupling straps 133 maintain their coupling of hip belt assembly 8 to frame assembly 5 as seen in FIG. 5. In the first mode, coupling straps 133 transfer the weight of backpack frame 1 to hip pad 130, and hence to the hips of person 3 (see FIG. 3). Suspension strap 136 is threaded, and may slide freely through, a slot 138 in hook 137, and the ends of suspension strap 136 are joined by, for example, stitching, on either lateral side of the rearward side of hip pad 130, at the area proximate where coupling straps 133 are joined to hip pad 130. Suspension strap 136 is elastic and may be constructed from, for example, elastic webbing. Hook 137 may be constructed from, for example, plastic or lightweight metal alloy, and includes a lip 139 that prevents it from easily slipping off loop 115. In the first mode, with backpack frame 1 not being worn (as in FIG. 1), suspension strap 136 provides an elastic support to keep hip pad 130 hoisted to prevent it from falling away from its position relative to lower frame member 30. With hook 137 hooked onto loop 115, suspension strap 136 is tensioned and pulls upwardly on hip pad 130, thereby keeping coupling straps 133 tensioned and hip pad 130 hoisted. This prevents hip pad 130 from falling away and dangling by coupling straps 133, which would make it difficult for person 3 when they are trying to put on backpack frame 1.

Referring to FIGS. 25A and 25B, coupling straps 133 also provide adjustment of the relative position of hip pad 130 to lower frame member 30 (as indicated by a distance shown by arrows 135) by the loosening or tightening of the free end of coupling straps 133 extending out from buckles 134. Loosening coupling straps 133 lengthens the portion of the strap that passes through ring 121, thereby increasing distance 135 and lowering the relative vertical position of lower frame member 30 to hip pad 130 (see FIG. 25A). Tightening coupling straps 133 shortens the portion of the straps that passes through rings 121, thereby decreasing distance 135 and raising the relative vertical position of lower frame member 30 to hip pad 130 (see FIG. 25B). Since lower frame member 30 is part of backpack frame 1, loosening and tightening coupling straps 133 lowers and raises, respectively, the relative vertical position of backpack frame 1 on the back of person 3. Referring back to FIG. 3, since the ends of coupling straps 133 are at the side of, and thus within easy reach of person 3, this adjustment may be done by person 3 even while backpack frame 1 is being worn. Also, the adjustment may be done individually for each coupling strap 133, thus allowing for the adjustment of the side-to-side lean of backpack frame 1. The elasticity of suspension strap 136 allows it to change length as coupling straps 133 are adjusted, yet still provide the tension needed to keep hip pad 130 hoisted when backpack frame 1 is not worn. With backpack frame 1 being worn and hip pad 130 cinched to the hips of person 3 (see FIG. 3), suspension strap 136 remains tensioned but no longer needs to hoist hip pad 130 as the downward pull of backpack frame 1 and any load it may carry keeps coupling straps 133 tensioned.

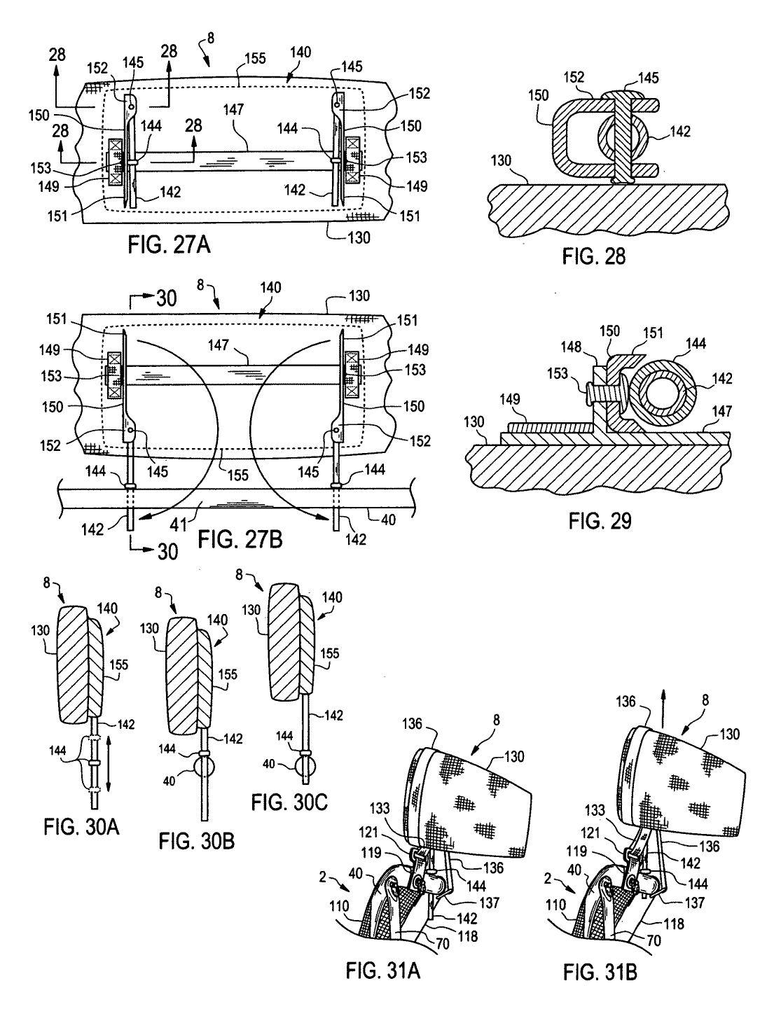

FIGS. 27A and 27B show fragmented rear plan views of hip belt assembly 8, oriented as it would be in the first and second mode, respectively, showing headrest support apparatus 140 with headrest support arms 142 retracted and extended, respectively. FIGS. 28 and 29 show fragmented sectional views of FIG. 27A along line 28-28 and line 29-29, respectively. Referring to FIGS. 27A to 28, in the first mode, headrest support apparatus 140 provides no function and support arms 142 are in their retracted position, tucked in under a support cover 155, as in FIG. 27A. In the second mode, headrest support apparatus 140 couples hip pad 130 to frame assembly 5 so that hip pad 130 can provide an adjustable height headrest for chair 2. Headrest support apparatus 140 includes a thin horizontal spreader bar 147 with a raised flange 148 proximate both of its ends. To each flange 148, a pin 153 (made from, for example, a pop rivet) transversely joins, a support bar 150, having a U-shaped cross-section (best seen in FIGS. 28 and 29), a long slender portion 151, and a short broad portion 152 at one end. Slender portion 151 allows support arms 142 to tuck in close to support bar 150 when they are retracted as in FIG. 27A and 27C; broad portion 152 provides an enlarged area for coupling support arm 142 to support bar 150. Support bars 150 provide extensions to support arms 142 to transfer the load of the head of person 3 on hip pad 130 down to support arms 142. One end of support arm 142 is pivotably coupled, by way of a pin 145 (made from, for example, a pop rivet) to portion 152 of support bar 150, and can pivot about the axis of pin 145 as shown by the semi-circular arrows in FIG. 27B. The ends of bar 147 are tucked into strips of webbing 149 joined by, for example, stitching, to the rearward side of hip pad 11. Bar 147 should be sufficiently flexible to allow it to conform to the curvature of hip pad 130 when worn by person 3, yet be rigid enough to maintain the separation of support bars 150. Bar 147 may be constructed from rigid, yet flexible materials such as, for example, molded plastic, or extruded aluminum alloy. Support bars 150 may be constructed from rigid lightweight materials such as, for example, aluminum alloy, and support arms 142 may be constructed from rigid lightweight materials such as, for example, circular cross-sectioned aluminum alloy tubing. Once extended, as in FIG. 27B, the free ends of support arms 142 may be inserted into holes 51 on lower frame member 30 to couple hip pad 130 to frame assembly 5, thus providing a headrest for chair 2.

FIG. 30A shows a fragmented sectional view of FIG. 27B along line 30-30, showing hip belt assembly 8, in the second mode, with support arm 142 having a stop ring 144 shown at alternate positions along support arm 142 (fourth section 40 is not shown here). FIGS. 30B and 30C show fragmented sectional views of FIG. 27B along line 30-30, showing hip belt assembly 8, in the second mode, positioned on fourth section 40 of lower frame member 30 as the headrest of the chair, showing it adjusted to a lower position and a higher position, respectively, thereby allowing the height of the headrest of the chair to be adjusted to accommodate a range of torso sizes. Referring to FIGS. 30A to 30C, and 5, stop ring 144 slides onto support arm 142 and may be adjusted by manually sliding it to different positions along the length of support arm 142 (as shown by the arrow in FIG. 30A) so as to select a limit for the length of support arm 142 that may be inserted into hole 51 in fourth section 40 (as shown in FIGS. 30B and 30C), thereby providing control of the height of the headrest and maintaining it at a fixed height. The bore of each stop ring 144 is somewhat smaller than the outside diameter of support arm 142 so that it frictionally grips support arm 142 to prevent it from sliding when providing a stop for support arms 142. Each stop ring 144 may be constructed from a resilient, frictional material such as, for example, rubber. FIGS. 31A and 31B show a fragmented side plan views of chair 2 showing the headrest adjusted to a relatively low and high position, respectively, and substantially correspond to the positions of the headrest shown in FIGS. 30B and 30C, respectively. The vertical arrow in FIG. 31B indicates the upward raising of the headrest height as compared to the headrest height in FIG. 31A. As can also be seen in FIGS. 4 and 5, suspension strap 136 maintains pull on hip pad 130 to keep it secured to frame assembly 5, and stop rings 144 maintain the headrest at a fixed height. Referring also to FIGS. 25A and 25B, cover 155 provides a barrier to prevent support arm apparatus 140 from rubbing and/or chaffing sheet 110, when in the first mode. Cover 155 may be constructed from, for example, nylon fabric, and joined by, for example, stitching, to the rearward side of hip pad 130 so as to secure its lateral ends and lower end leaving the upper end open, as a pouch, to allow a person to reach in under cover 155 to extend or retract support arms 142.

### F: Shoulder Strap Assembly

Referring to FIGS. 1 to 3, each shoulder strap assembly 9 has a somewhat conventional construction adapted to pass over the shoulder of person 3, and which includes support strap 161, and shoulder pad 160 having a grommet 162 disposed at its upper end and an adjustable buckle 163 disposed at its lower end. The upper end of each shoulder pad 160 is attached to frame assembly 5 by way of pin 35 inserted through grommet 162 and hole 34, and may be attached adjacent the upper end of hole 34 (shown) or the lower end of hole 34. The upper end of support strap 161 is threaded through buckle 163, providing a free end for adjusting the closeness of shoulder strap assembly 9 to the body of person 3. The lower end of support strap 161 is joined, along with buckle 134 by, for example, stitching, to one lateral side of the rearward side of hip pad 130 (see FIGS. 25A and 25B). In the first mode, shoulder'strap assemblies 9 provide conventional shoulder strap functionality that helps to stabilize the load and hold backpack frame 1 near the back of person 3. Each shoulder strap assembly 9 may transfer part of the load to person 3, but are not intended as the primary load-transferring members, as hip belt assembly 8 is best suited for transferring the majority of the load. In the second mode, shoulder strap assemblies 9 provide no specific function, and are kept off to the lateral sides to make room to sit on chair 2 (see FIGS. 4 to 6B).

### G: Operation of Invention

In use, convertible backpack frame 1000 may be used as backpack frame 1 in the first mode (see FIGS. 1 to 3), or as chair 2 with an adjustable height headrest and a reclinable backrest in the second mode (see FIGS. 4 to 6B). In the first mode, backpack frame 1 is worn in a conventional manner (see FIG. 3) and may be adjusted for fit, even while being worn, by tightening or releasing coupling straps 133, of which the free ends are easily accessed while wearing backpack frame 1, and where tightening them raises the position of backpack frame 1 on the back of person 3, and releasing them lowers it. Coupling straps 133 may also be adjusted individually to control the side-to-side lean of backpack frame 1. Tightening or releasing support straps 161 adjusts the nearness of backpack frame 1 to the back of person 3. The balance and fit of backpack frame 1 on the back of person 3 may be further adjusted by adjusting the attachment point of the upper end of shoulder strap assemblies 9 to frame assembly 5 by attaching third section 31 to fourth section 40 at a different hole 37. The separation of shoulder pads 160 may be adjusted by attaching them to the appropriate hole 34. Also, crossbar section 27 may be used as a convenient handle when lifting backpack frame 1 and, along with section 25, as a convenient strap-on point for gear.

To convert convertible backpack frame 1000 from the first mode as backpack frame 1 to the second mode as chair 2, person 3 first, if it is not already off, takes backpack frame 1 off their back. Backpack frame 1 is then place, preferably, in an upside-down orientation for easier access to locking apparatuses 80, which are then unlocked so that telescoping members 60 may extend. Lower frame member 30 is then rotated with respect to upper frame member 10 about the axis of pin 17, until the frame members are oriented as chair 2, with the backrest at a suitable angle of recline. Locking apparatuses 80 are then locked so that the length of telescoping members 60 remains fixed, thereby maintaining frame assembly 5 as a rigid unit oriented as chair 2. Preferably, with chair 2 placed on a suitable surface, hip belt assembly 130 may then be repositioned from the first mode function as a hip belt, to the second mode function as a headrest, by unhooking hook 137 from loop 115, then manually extending support arms 142, and inserting them into holes 51 up to the depth of stop ring 144, at the lower end of lower frame member 30. Hip pad 130 is now in position as the headrest and hook 137 may be hooked to loop 115 or be wrapped back over hip pad 130 and hooked to lower extension 118 (as shown) so as to keep hip pad 130 (the headrest) anchored to lower frame member 30; hip pad 130 may also be cinched via cinch strap 131 and cinch buckle 132, as in FIG. 4. The headrest height may be adjusted by manually sliding stop rings 144 to a suitable position. The recline of the backrest of chair 2 may be adjusted to any of a plurality of positions, from upright to fully laid back, by unlocking locking apparatuses 80 and rotating the backrest (lower frame member 30) to a suitable position and then relocking locking apparatuses 80.

By reversing the above steps, convertible backpack frame 1000 may be converted from the second mode as chair 2 to the first mode as backpack frame 1: unhook hook 137, pull support arms 142 out of holes 51 and retract support arms 142 back under cover 155, re-hook hook 137 to loop 115 to reposition hip belt assembly 8 to its first mode orientation, unlock locking apparatuses 80, pivot frame assembly 5 back to its first mode orientation, and relock locking apparatuses 80. Thus, it can be seen that the process of converting backpack frame 1 to and from chair 2 is a simple process that requires no tools, or assembly or disassembly of parts.

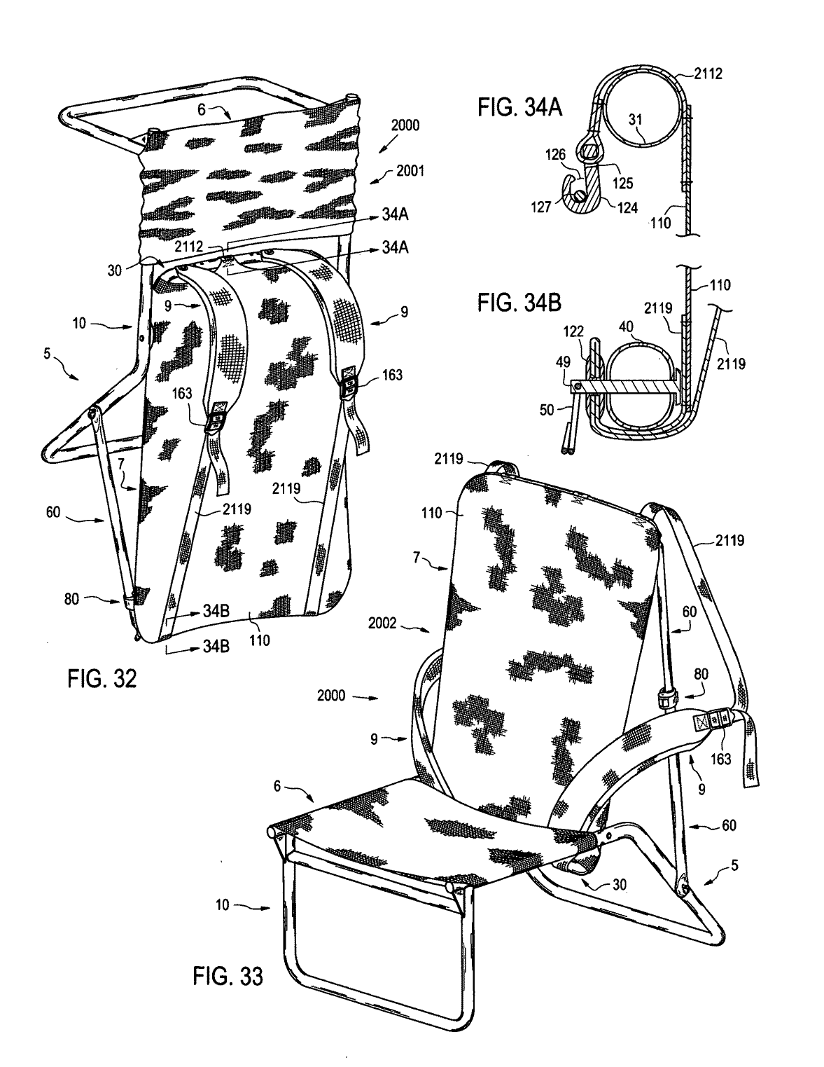

### DESCRIPTION OF ALTERNATE EMBODIMENTS—FIGS. 32-80B

### An Embodiment without the Hip Belt Assembly

FIG. 32 shows a front perspective view of a convertible backpack frame 2000, in the first mode as a backpack frame 2001, and FIG. 33 shows a front perspective view of convertible backpack frame 2000, in the second mode as a chair 2002. Convertible backpack frame 2000 is similar in configuration and operation to convertible backpack frame 1000, but does not include hip belt assembly 8, so that in the first mode, as in FIG. 32, it does not provide a hip belt, and in the second mode, as in FIG. 33, it does not provide a headrest. As such, in the first mode, the load of backpack frame 2001 is transferred, via shoulder strap assemblies 9, to the shoulders of the person. FIGS. 34A and 34B show fragmented side sectional views of FIG. 32 along lines 34A-34A and 34B-34B, respectively. FIG. 34A shows an upper extension 2112, similar to upper extension 112 from convertible backpack frame 1000, but without portion 114, loop 115, and stitch 116, none of which are included due to the absence of hip belt assembly 8. One end of extension 2112 is joined to the rearward side of sheet 110 and the other end is formed into a loop to which hook 124 attaches thus providing a tensioning point for the upper end of sheet 110. FIG. 34B shows an attachment strap 2119, similar to strap 119 from convertible backpack frame 1000, but without portion 123, which is not included due to the absence of hip belt assembly 8. One end of each strap 2119 is joined to the rearward side of sheet 110 and extends back to a fold through which grommet 122 is joined and then returns back over itself extending out and up to where it is attached to shoulder pad 160 via buckle 163 through which it is threaded. Straps 2119 provide an anchor point for sheet 110 to lower frame member 30 (similar to strap 119) and the support and adjustment strap (similar to that provided by adjustment strap 161) for the lower end of shoulder pads 160. Convertible backpack frame 2000 provides a backpack frame and a chair, but does not include a hip belt or a headrest, thereby simplifying its manufacture and operation, and decreasing its weight and cost.

### An Embodiment that Includes Cargo Compartments

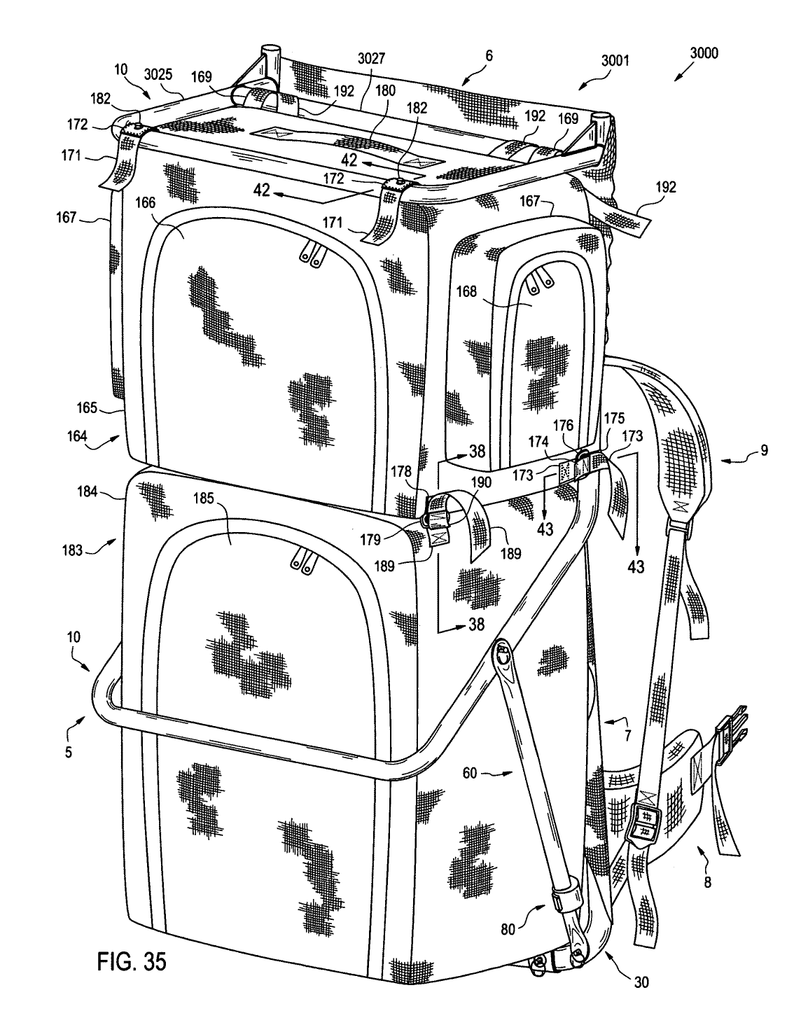

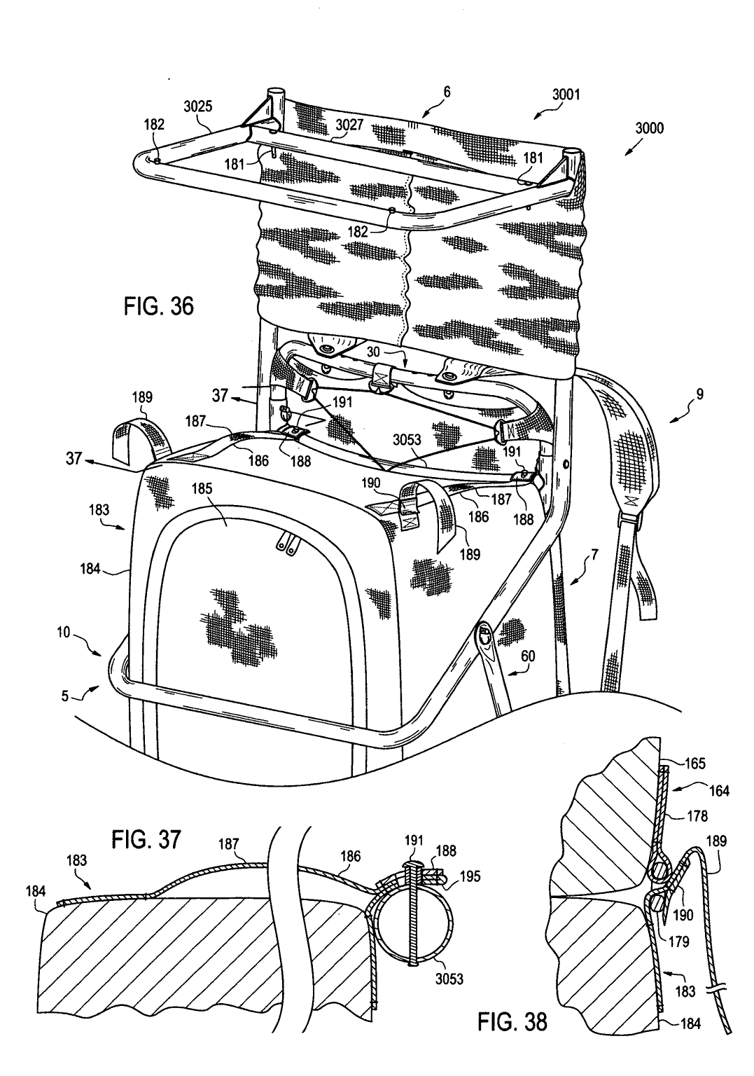

FIG. 35 shows a rear perspective view of a convertible backpack frame 3000, in the first mode as a backpack frame 3001, which includes an upper cargo compartment 164 and a lower cargo compartment 183, both detachably attached to convertible backpack frame 3000. Convertible backpack frame 3000 is similar in configuration and operation to convertible backpack frame 1000, but includes apparatus that allow for detachably attaching compartments 164 and 183. FIG. 36 shows a rear perspective view of convertible backpack frame 3000 (with upper compartment 164 detached) showing lower compartment 183 attached to backpack frame 3001. Referring to FIGS. 35 and 36, upper compartment 164 includes a main cargo container 165, and one or more optional side cargo containers 167 joined by, for example, stitching, to the lateral sides of container 165. Lower compartment 183 includes a cargo container 184. Containers 165, 167, and 184 include zippered openings 166, 168, and 185, respectively. Convertible backpack frame 3000 includes upper frame member 10 having a U-shaped section 3025, similar to section 25, but adapted to receive one or more attachment pins 182, disposed along the rearward portion of and extending upwardly through appropriate holes in, section 3025 (see FIGS. 35, 36, and 42). Convertible backpack frame 3000 also includes upper frame member 10 having a crossbar section 3027, similar to section 27, but adapted to receive one or more pins 181, disposed proximate each end of and extending downwardly through appropriate holes in, section 3027 (see FIG. 36). Convertible backpack frame 3000 includes lower frame member 30 having a crossbar section 3053, similar to crossbar section 53, but adapted to receive one or more attachment pins 191, disposed proximate each end of and extending upwardly through appropriate holes in, section 3053 (see FIG. 36). In one embodiment, compartments 164 and 183, provide about 5000 in.³ of combined capacity, which is ample for the needs of most backpacking trips.

FIGS. 37 to 43 show detailed views of the various apparatus that provides attachment points for compartments 164 and 183 to backpack frame 3001 and to each other. FIG. 37 shows a fragmented side sectional view of FIG. 36 along line 37-37. Referring to FIGS. 36 and 37, compartment 183 is detachably attached to lower frame member 30 via a pair of straps 186, each having an attachment tab 188 that snaps onto corresponding pins 191 in crossbar 3053. Straps 186 are disposed and joined on both lateral sides of the upper side of container 184; one end of strap 186 is joined to the upper rearward corner and the other end is joined to the upper forward corner of container 184. Attachment tab 188 is joined to the upper side of a fold 195 formed in strap 186 proximate its forward attachment to container 184. An opening is provided in fold 195 of substantially similar shape and coaxial to the corresponding opening in tab 188. Each strap 186 includes a middle portion 187, between the rearward attachment point and tab 188 that forms a convenient grasping handle for attaching and detaching strap 186 to pin 191. Each upper forward corner of compartment 183 is detachably attached to section 3053 by grasping middle portion 187 so as to snap tab 188 onto pin 191. A detailed description of this attachment mechanism is given below.

FIG. 38 shows a fragmented side sectional view of FIG. 35 along line 38-38 showing the attachment of compartment 183 to compartment 164. Referring to FIGS. 35, 36, and 38, compartment 164 includes a catch ring 179 mounted to a strap 178 that is joined to each lower rear corner of both lateral sides of container 165. Compartment 183 includes a strap 189 joined to each upper rear corner of both lateral sides of container 184, and with each strap 189 having joined to it a latch tab 190. Each of the upper rearward corners of compartment 183 is detachably attached to the lower rearward corners of compartment 164 by grasping and threading the free end of strap 189 through ring 179 until latch tab 190 catches on ring 179. A detailed description of this attachment mechanism is given below.

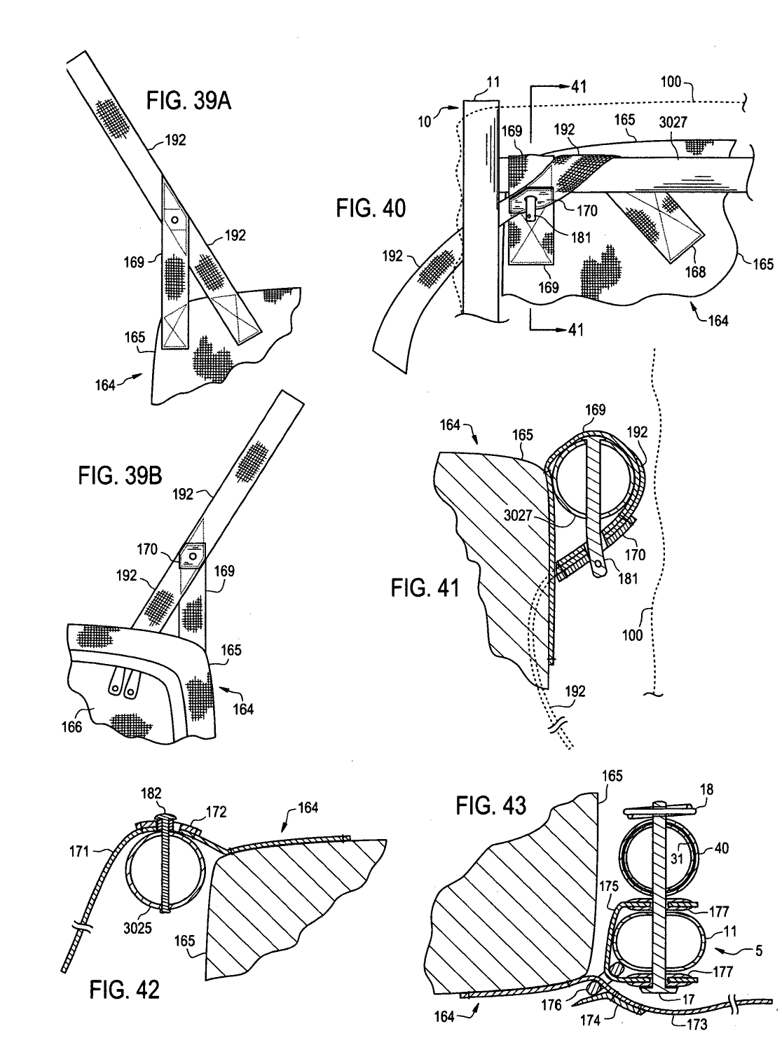

FIGS. 39A and 39B show front and rear plan views, respectively, of compartment 164 with a pair of straps 192 and 169 joined to an upper forward corner container 165. Both upper forward corners of container 165 have a pair of straps 192 and 169 joined to them. Strap 169 extends upwardly, and strap 192 extends upwardly and laterally outward from container 165. Strap 169 and strap 192 are joined at their intersection, where, at the rearward side of strap192, is joined attachment tab 170. The opening in tab 170 is substantially circular in cross section and slight larger in diameter that the diameter of the shaft of pin 181, so as to allow pin 181 to enter freely into the opening in tab 170. An opening is provided through straps 192 and 169, of substantially similar shape and coaxial to the corresponding opening in tab 170. FIG. 40 shows a fragmented front plan view of one of the upper corners of compartment 164 attached to section 3027, and FIG. 41 shows a fragmented side sectional view of FIG. 40 along line 41-41. Referring to FIGS. 40 and 41, straps 192 and 169 are wrapped over and around section 3027 such that pin 181 enters into the hole in tab 170, thereby securing compartment 164 to section 3027. The length of straps 192 and 169 that extend between container 165 and tab 170 are such that the hole in tab 170 is able to reach the tip of pin 181 when the straps are wrapped over and attached to section 3027, yet not so long as to let tab 170 slip off of pin 181 or let container 165 sag when tab 170 is attached to pin 181. Also, as can be seen in FIG. 41, the length of straps 192 and 169 are such that, once attached, tab 170 cannot slip off of pin 181 and the downward force from the weight of compartment 164 and its load keep straps 192 and 169 tensioned so as to keep tab 170 caught on pin 181. The free end of strap 192 may be grasped as a handle when attaching or detaching the strap and its tab 170 from pin 181. Grasping and pulling downwardly on the free end of strap 192, pulls tab 170 off of pin 181, thereby detaching it from section 3027. Strap 169 also helps transfer and distribute the load to container 165, and strap 192, being angled outwardly from container 165, tends to protrude out laterally (see FIG. 40) making it easier to grasp when attaching or detaching it from pin 181. Pin 181 may be constructed from, for example, a clevis pin, and held in its hole in crossbar 3027 by, for example, welding or adhesive-type tape across the head of the pin.

FIG. 42 shows a fragmented side sectional view of FIG. 35 along line 42-42 showing the upper rear corner of compartment 164 attached to section 3025. Referring to FIGS. 35 and 42, each upper rear corner of container 165 is detachably attached to section 3025 via a strap 171, having one end joined to the upper rear corner of container 165, and having joined to its upper side an attachment tab 172. An opening is provided through strap 171, of substantially similar shape and coaxial to the corresponding opening in tab 172. The upper rear corner of compartment 164 is detachably attached to section 3025 by grasping the free end of strap 171 so as to snap tab 172 onto pin 182. A detailed description of this attachment mechanism is given below.

FIG. 43 shows a fragmented side sectional view of FIG. 35 along line 43-43 showing the attachment of the lower forward corner of compartment 164 to frame assembly 5. Referring to FIGS. 43 and 35, each lower forward corner of compartment 164 is detachably attached to frame assembly 5 via a strap 173, having one end joined to the lower forward corner of container 165, and having a latch tab 174 joined to it. A catch ring 176 is attached to frame assembly 5 by a strap 175, having a grommet 177 at both ends, and which is attached to frame assembly 5 via pin 17, which passes through grommets 177. The lower forward corner of compartment 164 is detachably attached to frame assembly 5 by grasping and threading the free end of strap 173 through ring 176 until latch tab 174 catches on ring 176. A detailed description of this attachment mechanism is given below.

Thus, since compartments 164 and 183 are detachable, convertible backpack frame 3000 is a separate component from any cargo compartments (as is convertible backpack frame 1000) and can function as a backpack frame 3001 or a reclinable chair 2 independently of any cargo compartments, thus allowing chair 2 to be moved about without the burden of attached compartments. Also, the detachability of compartments 164 and 183 provides improved flexibility and access to these compartments since they can be accessed and moved about independent of backpack frame 3000, and the large, zippered openings 166, 168, and 185 readily provide access to the contents of compartments 164 and 183.

### An Embodiment having Separate Detachable Side Cargo Compartments

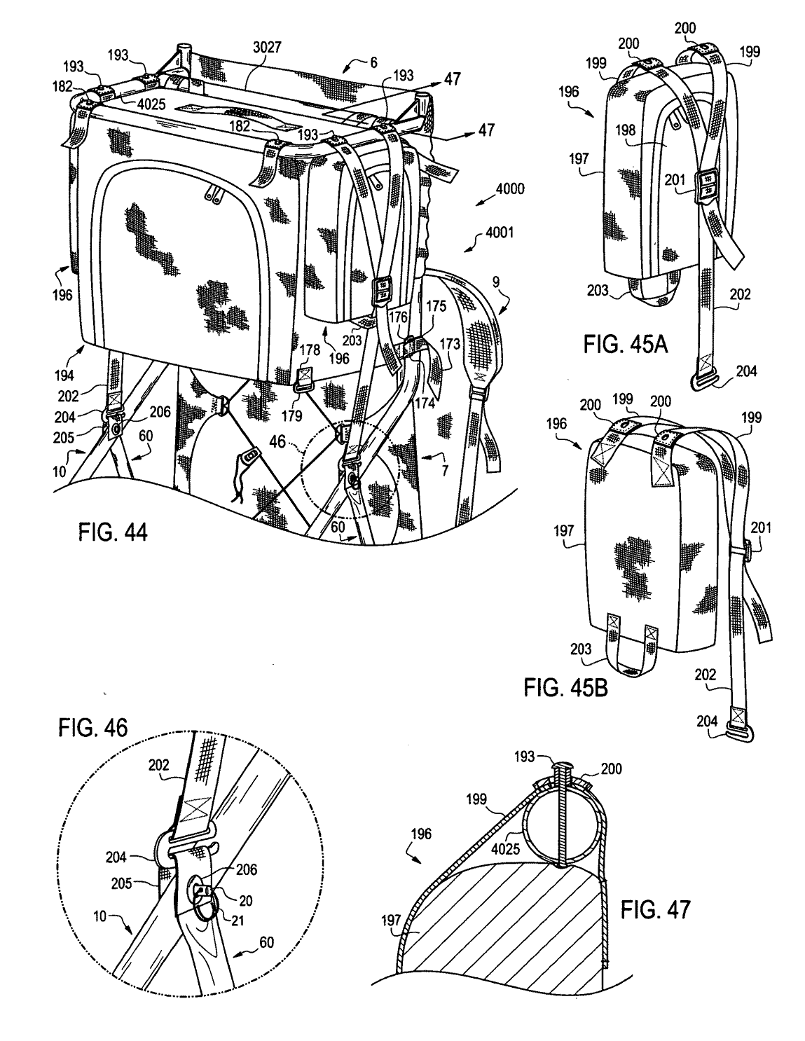

FIG. 44 shows a fragmented rear perspective view of a convertible backpack frame 4000, in the first mode as a backpack frame 4001, which includes an upper cargo compartment 194 and one or more separate side cargo compartments 196 that are detachably attached to convertible backpack frame 4000. Referring to FIG. 44, convertible backpack frame 4000 is similar in configuration and operation to convertible backpack frame 3000, but includes apparatus for detachably attaching side compartments 196. Compartment 194 is similar in configuration and operation to compartment 164, but does not include side containers 167. Compartment 183 (not shown) detachably attaches to convertible backpack frame 4000 in the same manner as it does to convertible backpack frame 3000. Convertible backpack frame 4000 includes a U-shaped second section 4025, similar in configuration and operation to U-shaped second section 3025, but which includes one or more attachment pins 193 on each lateral side that extend substantially upwardly and are spaced apart so as to provide attachment points for side compartments 196. Referring to FIGS. 45A and 45B, which show side perspective views, each about ninety degrees apart, respectively, of compartment 196, which includes a container 197 having a zippered opening 198. The interior portion of a strap 199 is threaded through the anchoring side of an adjustable buckle 201, each end of strap 199 is joined to the rearward side of container 197, and an attachment tab 200 is joined proximate each end of strap 199. A strap 202 is threaded through the adjusting side of buckle 201 and a hook 204 (similar to hook 137) is joined to the end of strap 202. Each end of a strap 203 is joined to the rearward side of container 197, forming a loop.

FIG. 46 shows an enlarged view of FIG. 44 indicated by circle 46, showing one of the attachment points of compartment 197 to frame member 10, and FIG. 47 shows a fragmented side sectional view of FIG. 44 along line 47-47 showing the attachment of compartment 196 to second section 4025. Referring to FIGS. 44 and 46, a strap 205 having a grommet 206 at both ends is attached to frame member 10 via pin 20, which passes through both grommets 206, forming a loop onto which hook 204 hooks, when compartment 196 is attached to convertible backpack frame 4000. Referring to FIGS. 44 and 47, compartment 196 attaches to convertible backpack frame 4000 by wrapping strap 199 over second section 4025 such that tabs 200 snap onto pins 193. Strap 202 is passed through the loop formed by strap 203, and hook 204 is then hooked onto the loop formed by strap 205. Strap 202 is tightened by grasping and pulling on the free end of strap 202, thus securing compartment 196 to convertible backpack frame 4000. Strap 203 helps to keep compartment 196 snug against the backpack, and prevents it from swinging freely. Compartment 196 may be detached from convertible backpack frame 4000 by loosening strap 202, unhooking hook 204 from the loop of strap 205, pulling strap 202 through the loop of strap 203, unsnapping tabs 200 from pins 193, and pulling compartment 196 away from convertible backpack frame 4000.

### An Embodiment of a Separate, Detachable Side Cargo Compartment

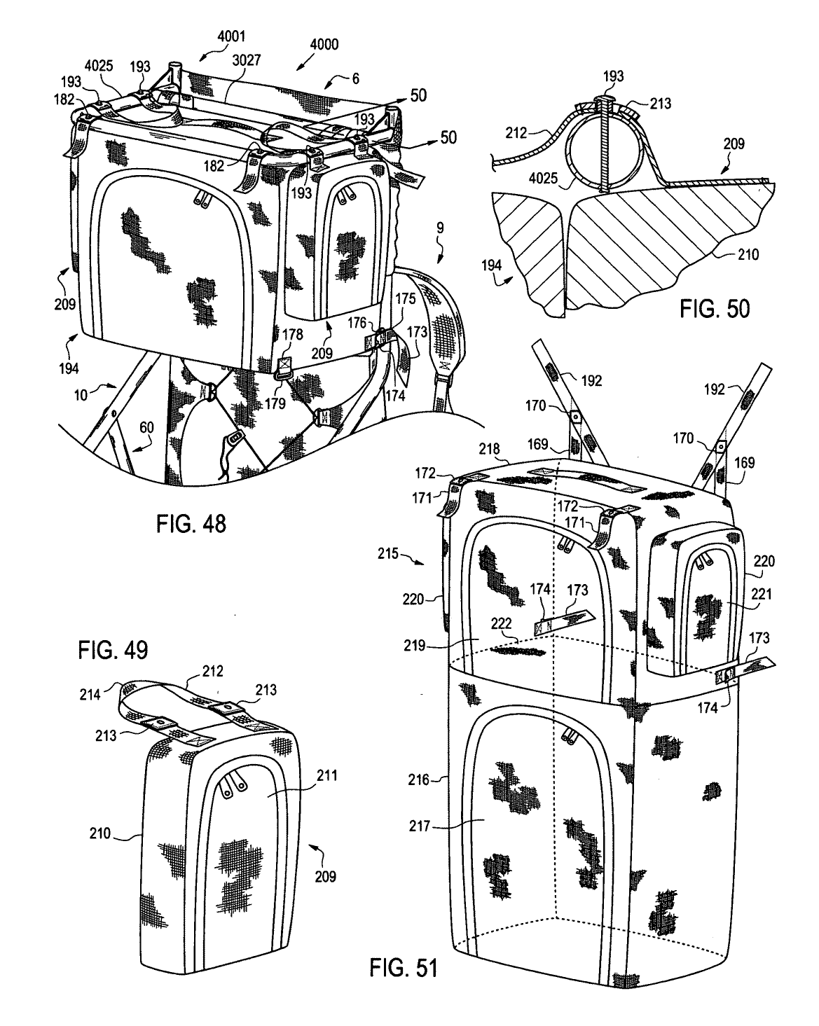

FIG. 48 shows a fragmented rear perspective view of convertible backpack frame 4000, in the first mode as a backpack frame 4001, with one or more separate detachably attached side cargo compartments 209. FIG. 49 shows a side perspective view of side compartment 209 that includes a container 210 with zippered opening 211, and an attachment strap 212 having a middle portion 214. The ends of strap 212 are joined proximate the sides of the upper side of container 210, and have joined to them, on their upper side proximate each end, an attachment tab 213. FIG. 50 shows a fragmented side sectional view of FIG. 48 along line 50-50 showing compartment 209 attached to second section 4025 via attachment strap 212 having tab 213 snapped onto pin 193. Referring to FIGS. 48 to 50, compartments 209 are attached to convertible backpack frame 4000 by wrapping strap 212 over second section 4025 such that tabs 212 snap onto pins 193; unsnapping tabs 212 from pins 193 detaches compartment 209. Middle portion 214 provides a grasping handle for compartment 209 when carrying it, or attaching or detaching it from convertible backpack frame 4000.

### An Embodiment of a Single Detachable Cargo Compartment

Referring to FIG. 51, which shows a rear perspective view of a single cargo compartment 215 having a lower container 216 with zippered opening 217, an upper container 218 with zippered opening 219, and one or more side containers 220, each with a zippered opening 221. A partition panel 222 separates lower container 216 from upper container 218. Similar to compartments 164 and 194, compartment 215 includes straps 169 and 192 and tab 170 joined to the each corner of its upper forward side, strap 171 and tab 172 joined to each corner of its upper rearward side, and strap 173 and latch tab 174 joined at each lateral side. Compartment 215 may be detachably attached to convertible backpack frames 3000 or 4000 in a similar manner to compartments 164 and 194, where tabs 170 attach to pins 181, tabs 172 snap onto pins 182, and latch tab 174 catches on ring 176. The hidden edges of containers 216 and 218, and of partition 222 are shown in outline.

All embodiments of cargo containers described above may be constructed from, for example, coated nylon fabric. Also, only a few of the many possible configurations of cargo compartments are disclosed above, however, as would be apparent to one skilled in the art, there are many other possible configurations of cargo compartments and cargo compartment openings, and many possible methods of detachably attaching compartments to the convertible backpack frames, and as such only a few are disclosed herein, but not so as to be regarded as limiting.

### Description of an Attachment Pin

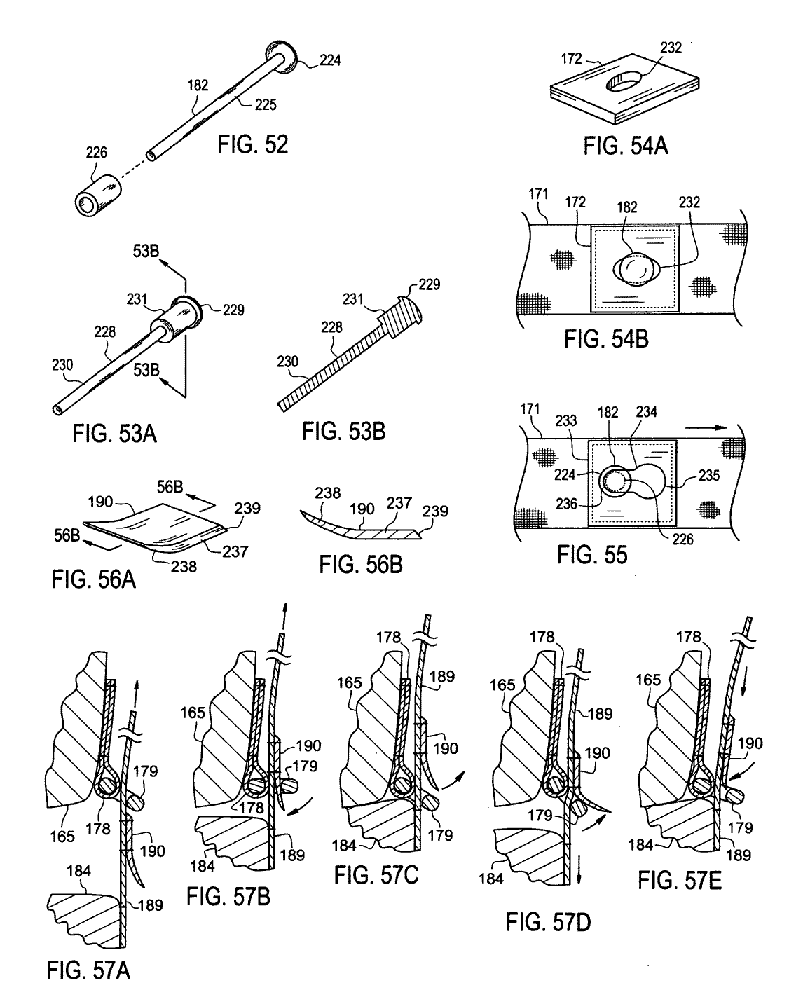

FIG. 52 shows an exploded perspective view of attachment pin 182. Referring to FIG. 52 and back to FIG. 42, pin 182 has a head 224, a shaft 225 and a sleeve 226 that slips onto shaft 225 up to head 224; the diameter of head 224 being somewhat larger than the outside diameter of sleeve 226. Pin 182 is inserted into an appropriately adapted hole in section 3025 and the end of shaft 225 is flattened, for example as a rivet would be, to retain pin 182 in its hole in section 3025. Pin 182 and sleeve 226 may be constructed from, for example, lightweight aluminum alloy. Only pin 182 is shown and described here, but pins 191 and 193 are configured and operate similarly.

### An Embodiment of an Attachment Pin

FIG. 53A shows a perspective view of an attachment pin 228, and FIG. 53B shows a side sectional view of FIG. 53A along line 53B-53B. Referring to FIGS. 53A and 53B, pin 228 is similar to pin 182 but does not include a separate sleeve 226, and is constructed as one piece that includes head 229, shaft 230, and a larger section 231 that provides the function of sleeve 226.

### Description of an Attachment Tab

FIGS. 54A and 54B show a perspective view of attachment tab 172 and a top plan view of attachment tab 172 joined to strap 171 and attached to attachment pin 182, respectively. Referring to FIG. 54A and FIG. 54B, opening 232 may have a somewhat oval or elliptical shape such that the short dimension of opening 232 is slightly smaller than the diameter of head 224 of pin 182 so that when tab 172 is pushed onto pin 182, the head of pin 182 spreads open opening 232, allowing pin 182 to snap into opening 232, thus preventing tab 172 from easily slipping off of pin 232. Only tab 172 is shown here, but tabs 188, 200, and 213 are configured and operate similarly.

### An Embodiment and Operation of a Latch Tab

FIG. 55 shows a top plan view of an attachment tab 233, attached to pin 182. Referring to FIG. 55, tab 233 is similar to tab 172 but includes a keyhole shaped opening 234 having a small circular area 236 and a large circular area 235. Opening 234 is shaped such that the diameter of circular area 235 will allow head 224 of pin 182 to pass through it, but the diameter of circular area 236 will not allow head 224 to pass through it, but will allow sleeve 226 (shown in double-dot-dash outline) to slide horizontally into it. As such, pin 182 can be inserted through opening 234 via circular area 235, and then slid, by manually pulling and/or by the force of the load (shown by horizontal arrow) into circular area 236, such that tab 172 cannot be easily lifted off of pin 182 due to head 224 being too large to easily pass through area 236.

### Description and Operation of a Latch Tab

FIG. 56A shows a perspective view of latch tab 190 and FIG. 56B shows a side sectional view of FIG. 56A along line 56B-56B. FIGS. 57A to 57E show fragments side sectional views of the steps of operation of latching and unlatching strap 189 and latch tab 190 onto and off of catch ring 179. Referring to FIGS. 56A to 57E, latch tab 190 includes a relatively thick body portion 237 having a beveled leading edge 239, and a flexible upwardly curved and tapered flap portion 238. Latch tab 190 may be joined to strap 189 via stitching through body portion 237. Leading edge 239 is beveled to allow latch tab 190 to enter into ring 179 more easily. Flap portion 238 is upwardly curved to allow latch tab 190 to catch on ring 179. When joined to strap 189, body portion 237 is flat in contact against strap 189 so that flap portion 238 extends away from strap 189 so it may catch on ring 179.

Referring to FIGS. 57A to 57E, to better show operation of latch tab 190, FIG. 57A shows the first step of engaging latch tab 190 to ring 179 whereby one end on strap 189 is joined to container 184 and the opposite free end of strap 189 is inserted (in the direction of the arrow) through ring 179. FIG. 57B shows the free end of strap 189 being pulled (in the direction of the straight arrow) through ring 179 to the extent that latch tab 190 is being flattened (shown by curved arrow) as it passes into the smaller opening of ring 179. FIG. 57C shows latch tab 190 after strap 189 has been pulled through ring 179 sufficiently enough to allow latch tab 190 to snap free of ring 179 (as shown by the arrow) such that flap portion 238 of latch tab 190 extends away from strap 189 and cannot fit back through the opening of ring 179. FIG. 57D shows strap 179 having been released and where the pull of the load (shown by the straight arrow) pulls strap 189 back through ring 179 such that latch tab 190 catches on and is bent back by ring 179 (shown by the curved arrow), thereby preventing strap 189 from being pulled back through ring 179. FIG. 57E shows latch tab 190 being squeezed back towards strap 189 (as may be done by a person's forefinger and thumb) so that latch tab 190 and strap 189 may pass back through ring 179, thereby unlatching latch tab 190 from ring 179 and freeing it so that strap 189 may pass out through ring 179, thus freeing container 184 from container 165. Only the configuration and operation of strap 189, latch tab 190, and catch 179, is shown here, but strap 173, latch tab 174, and ring 176 have a similar configuration and operation.

All attachment tabs and latch tabs described above may be constructed from resilient, flexible materials such as, for example, stitchable molded elastomeric plastic, and joined to their respective straps by, for example, stitching.

### An Embodiment that Includes Frame Fittings

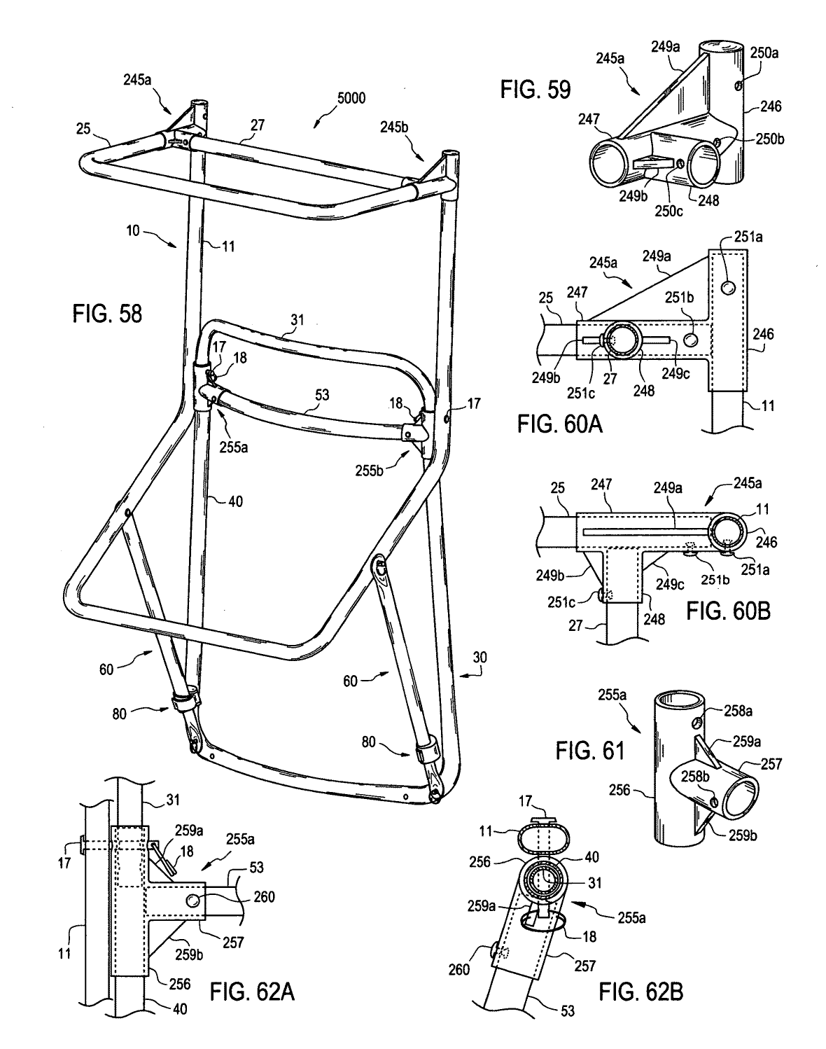

FIG. 58 shows a rear perspective view of a frame assembly 5000, in the first mode, which operates and is constructed similarly to frame assembly 5, but has various frame sections detachably attached together by fittings, instead of by welding. Referring to FIG. 58, first section 11, second section 25, and crossbar section 27 are joined together on both lateral sides of first member 10 by fittings 245a and 245b, and fourth section 40 and crossbar section 53 are joined together on both lateral sides of second member 30 by fittings 255a and 255b. Being on opposite sides of the frame assembly, fittings 245a and 245b are mirror replicas of each other, and fittings 255a and 255b are mirror replicas of each other. Fittings 245a, 245b, 255a, and 255b, may be constructed from, for example, molded plastic, or from welded sections of lightweight, aluminum alloy tubing.

FIG. 59 shows a rear perspective view of fitting 245a, and FIGS. 60A and 60B show fragmented side and upper plan views, respectively, of fitting 245a fitted to frame assembly 5000, and showing (in outline) the portion of the frame sections inserted into fitting 245a. Referring to FIGS. 58 to 60B, fitting 245a includes a vertical tubular section 246, a rearward extending horizontal tubular section 247 substantially perpendicular to section 246, and a lateral horizontal tubular section 248 substantially perpendicular to section 247. One or more gussets 249a, 249b, and 249c may be included to increase the strength where section 246, 247, and 248 meet. The frame sections of first member 10 are joined together via fittings 245a and 245b by inserting the ends of crossbar section 27, second section 25, and first section 11, into the open end of section 248, section 247, and section 246, respectively, such that the ends of crossbar section 27 abut second section 25 and the ends of second section 25 abut first section 11 (see FIGS. 60A and 60B). First section 11, second section 25, and crossbar section 27 may be retained in the fittings by pins 251a, 251b, and 251c, respectively, through holes 250a, 250b, and 250c, respectively. Appropriate holes in first section 11, second section 25, and crossbar section 27 are adapted to receive pins 251a, 251b, and 251c, respectively.

FIG. 61 shows a rear perspective view of fitting 255a, and FIGS. 62A and 62B show fragmented rear and upper plan views, respectively, of fitting 255a fitted to frame assembly 5000, and showing (in outline) the portion of the frame sections inserted into fitting 255a. Referring to FIGS. 61 to 62B, fitting 255a includes a vertical tubular section 256 and a sideward extending horizontal tubular section 257 substantially perpendicular to section 256. The frame sections of second member 30 are joined together via fittings 255a and 255b by inserting the ends of crossbar section 53 into the open end of section 257, and inserting the ends of fourth section 40 into the lower open end of section 256, such that the ends of crossbar section 53 abut fourth section 40. One or more gussets 259a and 259b may be included to increase the strength where section 256 and 257 meet. A hole 258a in fittings 255a and 255b permit the passing of pin 17 through the fittings, whereby pins 17 also serve to retain the fittings on fourth section 40. Crossbar 53 may be retained in, and prevented from turning inside, the fittings by a pin 260, through a hole 258b in each fitting. Appropriate holes in crossbar 53 are adapted to receive pin 260.

Pins 251a, 251b, 251c, and 260 may be made from, for example, a pop rivet as shown, or also from, for example, other (easily removable) fasteners such as snap-in pins, sheet metal screws, clevis pins, bolts, etc., thereby permitting the frame sections to be detachably attached in the fittings. The frame sections may also be retained in the fittings by adhesives such as, for example, epoxy. The inside diameter and/or inside texture of the tubular sections, and/or the outside surface of the ends of the frame sections may also be adapted so that the frame sections are frictionally retained in the fittings without the need for pins or other retaining apparatus. With fittings 245a, 245b, 255a, and 255b, the tubular sections of frame assembly 5000 may also be constructed from, for example, plastics or composite tubing. Also, because of the detachable nature of the fittings, the construction of frame assembly 5000 does not required special assembly techniques or operations, such as welding, and so frame assembly 5000 can be quickly and easily assembled. Moreover, any damaged component parts may be readily replaced.

### An Embodiment of a Locking Apparatus

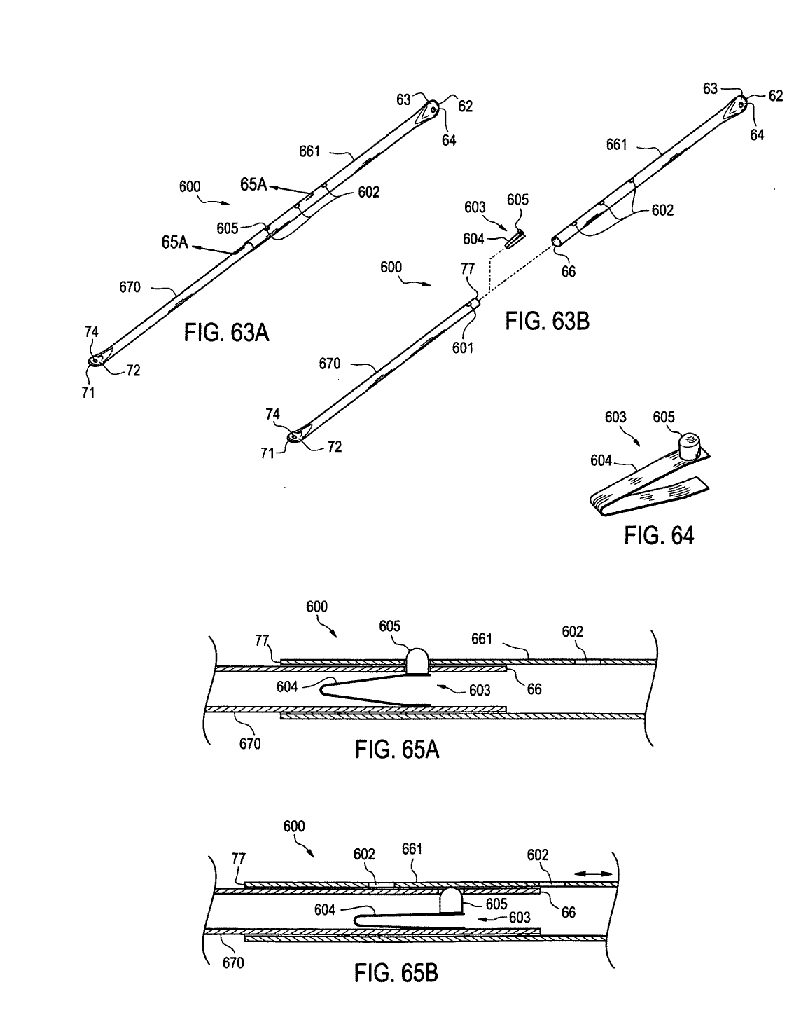

FIGS. 63A and 63B show perspective and exploded perspective views, respectively, of a tubular telescoping member 600, with FIG. 63A showing telescoping member 600 in a locked state. FIG. 64 shows a perspective view of a locking apparatus 603. Referring to FIGS. 63A to 64, telescoping member 600 is similar in function and operation to telescoping member 60, but includes locking apparatus 603 instead of locking apparatus 80. Telescoping member 600 includes a tubular outer section 661 (similar to tubular section 61) having a plurality of radial holes 602 that are spaced apart and align along the length of section 661, a tubular inner section 670 (similar to tubular section 70) having a radial hole 601 proximate its open end 77, and locking apparatus 603 that includes a V-shaped spring 604 and a knob or pin 605. Hole 601 and holes 602 pass through only one wall of section 670 and section 661, respectively. Like section 61, section 661 includes a closed end 62 adapted to attach to upper frame member 10, and an open joint end 66 that is telescopically joined to inner section 670. Like section 70, section 670 includes a closed end 71 adapted to attach to lower frame member 30, and an open joint end 77 that is telescopically joined to outer section 661. Referring to FIG. 63B, joint end 66 is adapted to receive joint end 77 to permit inner section 670 to slide into and out of outer section 661, thereby providing the telescoping action that allows telescoping member 600 to change length. As such, outer section 661 may have a larger diameter to fit over inner section 670.

FIG. 65A shows a fragmented side sectional view of FIG. 63A along line 65A-65A with telescoping member 600 in a locked state, and FIG. 65B shows the view of FIG. 65A with telescoping member 600 in an unlocked state. Referring to FIG. 65A, hole 601 is aligned with one of the holes 602 so that pin 605 is able to pass into a hole 602, pushed by the force of spring 604, and as such prevent section 661 from sliding relative to section 670, and thereby maintain telescoping member 600 in a locked state. Referring to FIG. 65B, the top of pin 605 is pressed on by the wall of section 661, compressing spring 604 such that sections 661 and 670 are able to slide in either direction (shown by 2-headed arrow) relative to each other, whereby either of the sections may slide until one of holes 602 aligns with hole 601 and pin 605 pops into the hole 602 so as to adjust telescoping member 600 to a desired length.

Locking apparatus 603, by compressing spring 604 is adapted to fit into, and remain in, open end 77 of section 670 (see FIG. 63B) such that pin 605 pops into and remains in hole 601. Pin 605, and holes 601 and 602, are adapted such that pin 605 may freely pass through the holes. Pin 605 may have a rounded upper surface (best seen in FIGS. 65A and 65B) to facilitate entering into hole 601 and entering and exiting holes 602. Spring 604 has substantially equal length arms, and may be constructed from flexible resilient materials such as, for example, a strip of spring steel. Pin 605 is joined by, for example, welding, to the outward side of one arm of spring 604.

In operation, a person may adjust the length of telescoping member 600 by manually pressing in pin 605, with, for example, the thumb and forefinger, until section 661 is able to slide past section 670 to where pin 605 aligns with one of the holes 602 and pops into it. As would be apparent to one skilled in the art, many other types of locking apparatus are possible for locking the telescoping members including, for example, those types common in telescoping walking poles and telescoping tripod legs.

### An Embodiment of the U-Shaped First Section

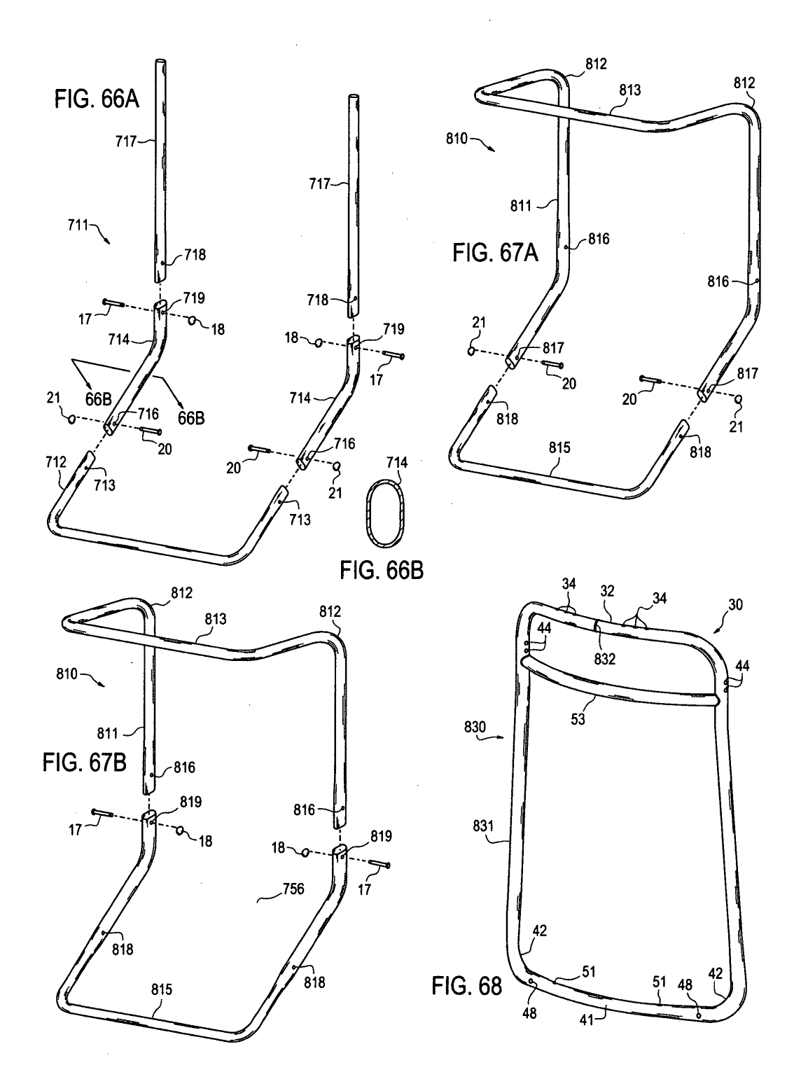

FIG. 66A shows an exploded rear perspective view of a U-shaped first section 711. FIG. 66B shows a sectional view of FIG. 66A along line 66B-66B. Referring to FIGS. 66A, first section 711 is similar in function and operation to U-shaped first section 11, but is constructed from a plurality of separated sections. First section 711 includes a lower base section 712, a plurality of middle sections 714, and a plurality of upper sections 717. The ends of sections 714 are adapted to slidably receive, by insertion, the open ends of sections 712 and the lower ends of sections 717. Proximate the ends of sections 714 are holes 716 and 719, which, when sections 712 and 717 are received into section 714, align with holes 713 and 718, respectively, so that pins 20 and 17 when inserted into holes 716 and 719, respectively, also pass through holes 713 and 718, respectively, thereby forming first section 711 into a single unit. In the context of a complete frame assembly, pins 20 would also pass through holes 64 in telescoping members 60. Also, as an alternate embodiment of first section 711, sections 714 and section 712 could be combined as a single section and, the ends of which, could be attached to sections 717, or sections 714 and 717 could be combined into single sections and attached to the ends of section 712; these embodiments would reduce the number of separate sections that needed to be attached together. Referring to FIG. 66B, the cross-section of section 714 may be partially flattened for strength, similar to portion 22. Separate frame sections, as in first section 711, provide for partial disassembly of the backpack frame, which provides for smaller packaging, easier transportation, and efficient storage.

### An Embodiment of the Upper Frame Member

FIGS. 67A and 67B show exploded rear perspective views of two variations of an upper frame member 810, respectively. Referring to FIGS. 67A and 67B, upper frame member 810 is similar in function and operation to upper frame member 10, but is constructed from a plurality of detachable sections. Upper frame member 810 includes a U-shaped lower section 815, and an inverted U-shaped upper section 811 having bends 812 at both lateral sides forming a rearwardly extending second U-shaped section 813 that provides the functionality of second section 25.

In FIG. 67A, the open ends of section 811 are adapted to slidably receive, by insertion, the open ends of sections 815, and in FIG. 67B, the open ends of section 815 are adapted to slidably receive, by insertion, the open ends of sections 811. In FIG. 67A, proximate the open ends of section 811 are holes 817, which, when section 815 is received into section 811, align with holes 818 that are proximate the open ends of section 815, so that pin 20, when inserted into hole 817, also passes through hole 818, thereby forming upper section 811 and lower section 815 into a single rigid member as upper frame member 810. In FIG. 67B, proximate the open ends of section 811 are holes 816, which, when section 811 is received into section 815, align with holes 819 that are proximate the open ends of section 815, so that pin 17, when inserted into hole 819, also passes through hole 816, thereby forming upper section 811 and lower section 815 into a single rigid member as upper frame member 810.

The open ends of sections 811 and 815 are partially flattened for strength and have cross sections similar to that shown in FIG. 66B. In the context of a complete frame assembly, pins 20 would also pass through holes 64 in telescoping members 60, and pins 17 would also pass through holes 44 and 37 in lower frame member 30. The separate frame sections of upper frame member 810 provide for simplified manufacture as well as partial disassembly of the backpack frame, which provides for smaller packaging, easier transportation, and efficient storage.

### An Embodiment of the Lower Frame Member

Referring to FIG. 68, which shows rear a perspective view of a lower frame member 830 similar to lower frame member 30; lower frame member 830 may be constructed from a single tubing section 831, thus replacing third section 31 and fourth section 40. The ends of tubing section 831 may be joined, for example, at its upper end by a weld 832. A sleeve (not shown) surrounding the ends of tubing section 831, instead of weld 832, could also be used to join and strengthen the ends of tubing section. As in lower frame member 30, lower frame member 830 includes holes 34, 44, 48, and 51, flattened corners 42, horizontal portions 32 and 41, and crossbar section 53.

### An Embodiment of a Headrest Support Apparatus

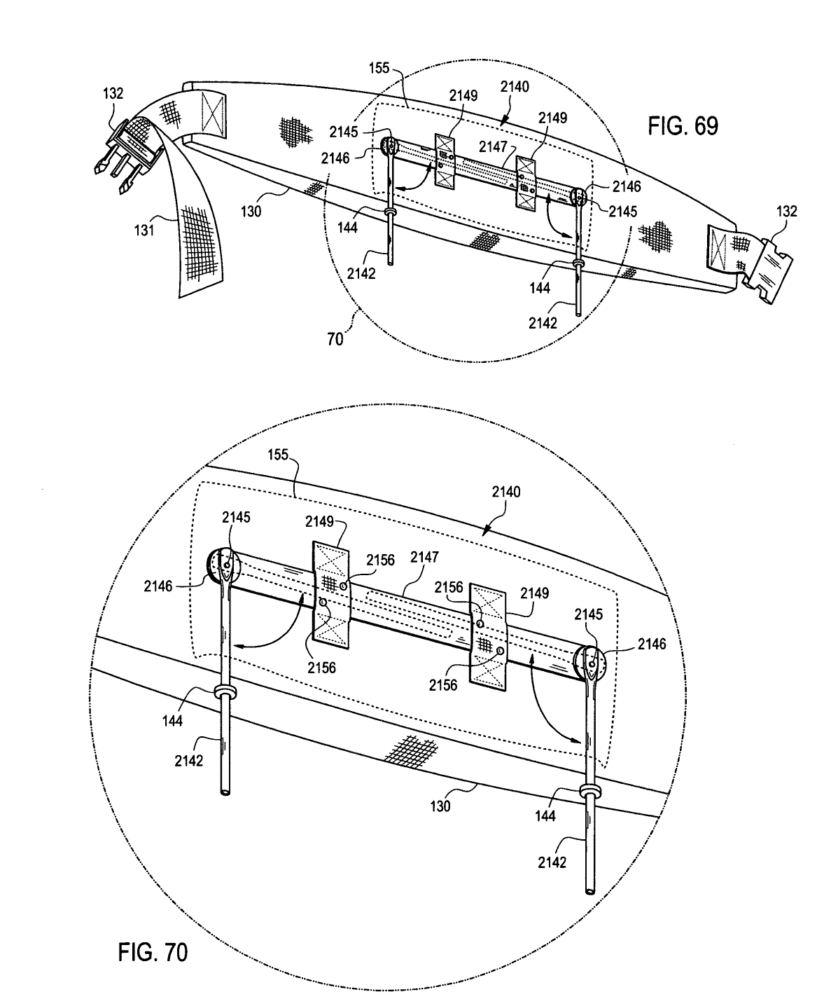

FIG. 69 shows a perspective view of a headrest support apparatus 2140 attached to the rearward side of hip pad 130. FIG. 70 shows an enlarged view of FIG. 69 indicated by circle 70. Referring to FIGS. 69 and 70, headrest support apparatus 2140 is similar in function to headrest support apparatus 140, and includes a thin horizontal spreader bar 2147 to which at each end is pivotably attached a support arm 2142 via a pivot pin 2145 and a washer 2146, and one or more attachment straps 2149 joined to bar 2147 via pins 2156 and joined to the rearward side of hip pad 130. FIGS. 69 and 70 show support arms 2142 in their extended position, oriented as they would be in the second mode, when inserted in holes 51. In FIG. 70, support arms 2142 are shown in their retracted position in outline. The ends of each arm 2142, pivotably attached to bar 2147, may be flattened so that it lays flat against washer 2146 and better distribute its load to bar 2147. Each support arm 2142 includes stop ring 144 to control the height of the headrest. Support arms 2142 may be manually pivoted about the axis of pin 2145 (shown by the double-headed curved arrows) to extend out of cover 155, so that their free end can be inserted in holes 51 to couple hip pad 130 to frame assembly 5, thus providing a headrest for chair 2. Pins 2145 and 2149 may be made from, for example, pop rivets. Support arms 2142 and bar 2147 have material properties similar to support arms 142 and bar 147, respectively.

### An Embodiment of a Headrest Support Apparatus

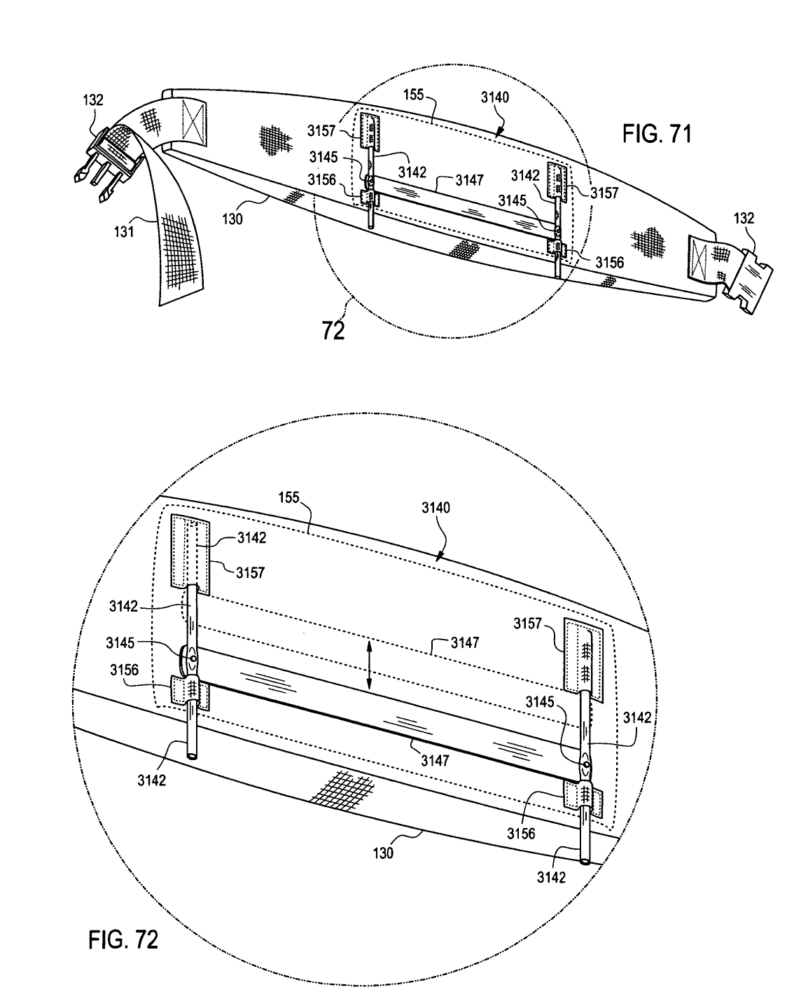

FIG. 71 shows a perspective view of a headrest support apparatus 3140 attached to the rearward side of hip pad 130. FIG. 72 shows an enlarged view of FIG. 71 indicated by circle 72. Referring to FIGS. 71 and 72, headrest support apparatus 3140 is similar in function to headrest support apparatus 140, but does not provide adjustable headrest height. Headrest support apparatus 3140 includes a horizontal cross bar 3147 to which at each end is attached a support arm 3142 via a pin 3145, a plurality of lower guide sleeves 3156, and a plurality of upper guide sleeves 3157. Sleeve 3156 and 3157 may be constructed from, for example, nylon webbing, with their edges joined to the back of hip pad 130 by, for example, stitching, to form sleeves adapted to allow passage of arm 3142 through the sleeves. One end of arms 3142 is inserted into upper sleeves 3157 and the opposite end of arms 3142 pass through sleeves 3156. In FIGS. 71 and 72, support arms 3142 and bar 3147 are shown in their extended position, oriented as they would be in the second mode, when inserted in holes 51. In FIG. 72, support arms 3142 and bar 3147 are shown in their retracted position in outline, with the double-headed arrow showing the shift in position between retracted and extended. Apparatus 3140 may be manually shifted from its retracted position to its extended position with arms 3142 extending out of cover 155, so that the free ends of arms 3142 extend out sufficiently to be inserted through holes 51 to couple hip pad 130 to frame assembly 5, thus providing a headrest for chair 2. Sleeves 3156 also provide a stop for arms 3142 and bar 3147 so that when extended, arms 3142 remain in sleeves 3157 and do not pop out. The portion of arm 3142 surrounded by sleeve 3157 has a length such that a portion of the lower end of arm 3142 remains held in sleeve 3157 with apparatus 3140 in its extended position. Pins 3145 and may be made from, for example, pop rivets. Support arms 3142 and bar 3147 have material properties similar to support arms 142 and bar 147, respectively.

### An Embodiment of a Headrest Support Apparatus

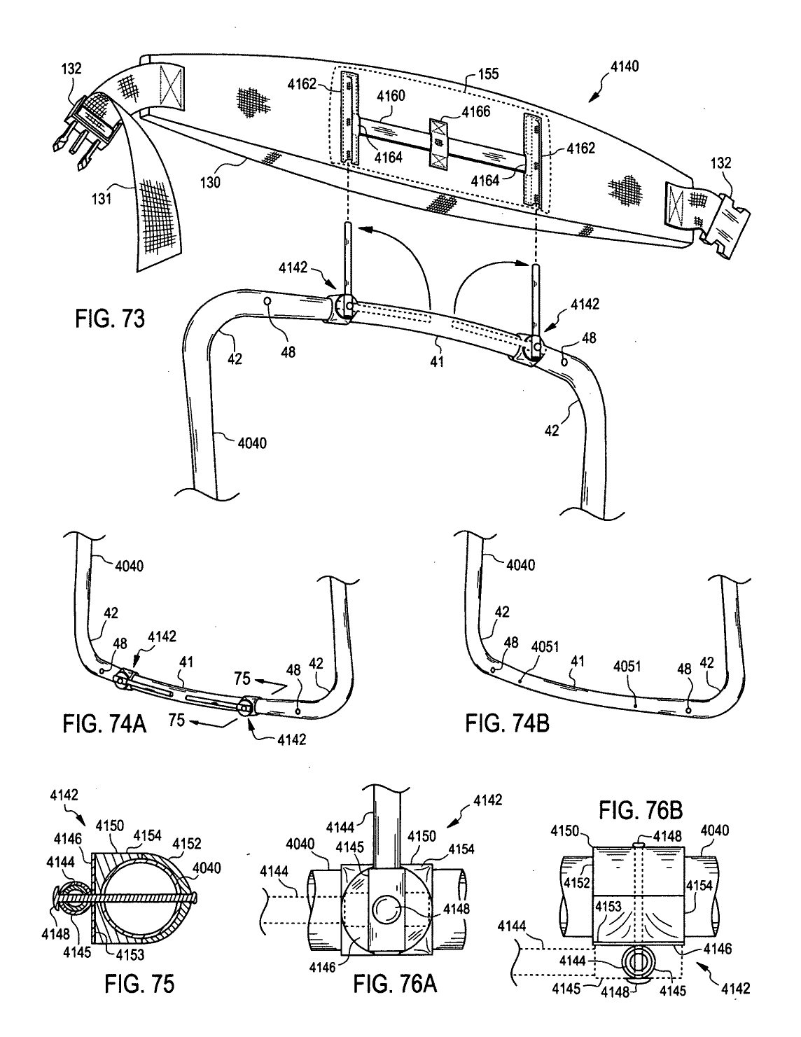

Referring to FIG. 73, which shows a perspective view of a headrest support apparatus 4140, that includes a plurality of support arm apparatuses 4142 attached to crossbar portion 41 of a U-shaped fourth section 4040, a plurality of sleeves 4162, a horizontal crossbar 4160, and an attachment strap 4166. Headrest support apparatus 4140 functions similarly to headrest support apparatuses 140 and 2140, but has support arms 4144 that are pivotably coupled (shown by curved arrows) to crossbar portion 41 so as to extend upwardly in the second mode so that they may enter into sleeves 4162 (shown by dot-dash line) to support hip pad 130 as a headrest. Support arms 4144 retract to a horizontal orientation in the first mode (shown in outline) so as to tuck in close to crossbar 41 and be out of the way. Each sleeve 4162 may be constructed from, for example, nylon webbing, with its edges joined to one lateral side of the back of hip pad 130 by, for example, stitching, to form vertical sleeves adapted to receive a support arm 3144. The lateral ends of support bar 4160 may be tucked into lateral openings 4164 in each sleeve 4162, and further held in place by attachment strap 4166.

FIG. 74A shows a fragmented rear perspective view of the lower frame member, oriented as it would be in the first mode as a backpack frame, with support arms 4144 pivoted to their retracted first mode orientation. FIG. 74B shows a fragmented rear perspective view of lower frame member 4040, oriented as it would be in the first mode, showing horizontal holes 4051. Fourth section 4040 is similar to section 40, but includes horizontal holes 4051 (instead of holes 51) adapted to receive pins 4148 of support arms apparatuses 4142.

FIG. 75 shows a side sectional view of FIG. 74B along line 75-75. FIGS. 76A and 76B show fragmented rear and upper plan views, respectively, of support arm apparatus 4142 attached to lower frame member 4040, with lower frame member 4040 oriented as it would be in the second mode as a chair 2, and showing support arm 4144 in its first mode (shown in outline) and second mode orientation. Referring to FIGS. 75-76B, each support arm apparatus 4142 includes support arm 4144 with an arm support 4145 pivotably attached, via a pin 4148 and a support arm bracket 4150, to crossbar 41. Arm support 4145 surrounds support arm 4144 to strengthen the pivot point around pin 4148. Bracket 4150 is adapted to fit around crossbar 41 and includes a forward portion 4152 and a rearward portion 4154 each having a hole that aligns coaxially with hole 4051 to allow pin 4148 to pass through. Portion 4154 includes a flat forward face 4153 to provide a support surface against which support arm 4144 contacts so as to prevent support arm 4144 from bending back from the force of the headrest in the second mode. Also, a washer 4146 is disposed between face 4153 and support arm 4144 to assist the pivoting of support arm 4144. Pin 4148 also functions to clamp portion 4152 and portion 4154 together onto crossbar 41 and press support arm 4144 against washer 4146 so as to frictionally hold support arm 4144 in the position it is manually rotated to. Support arms 4144 may be manually rotate to and from their first and second mode orientations. Support arms 4144 and bar 4160 have material properties similar to support arms 142 and bar 147, respectively. Forward portion 4152 and rearward portion 4154 may be constructed from, for example, molded plastic such as nylon.

### An Embodiment of the Coupling Straps

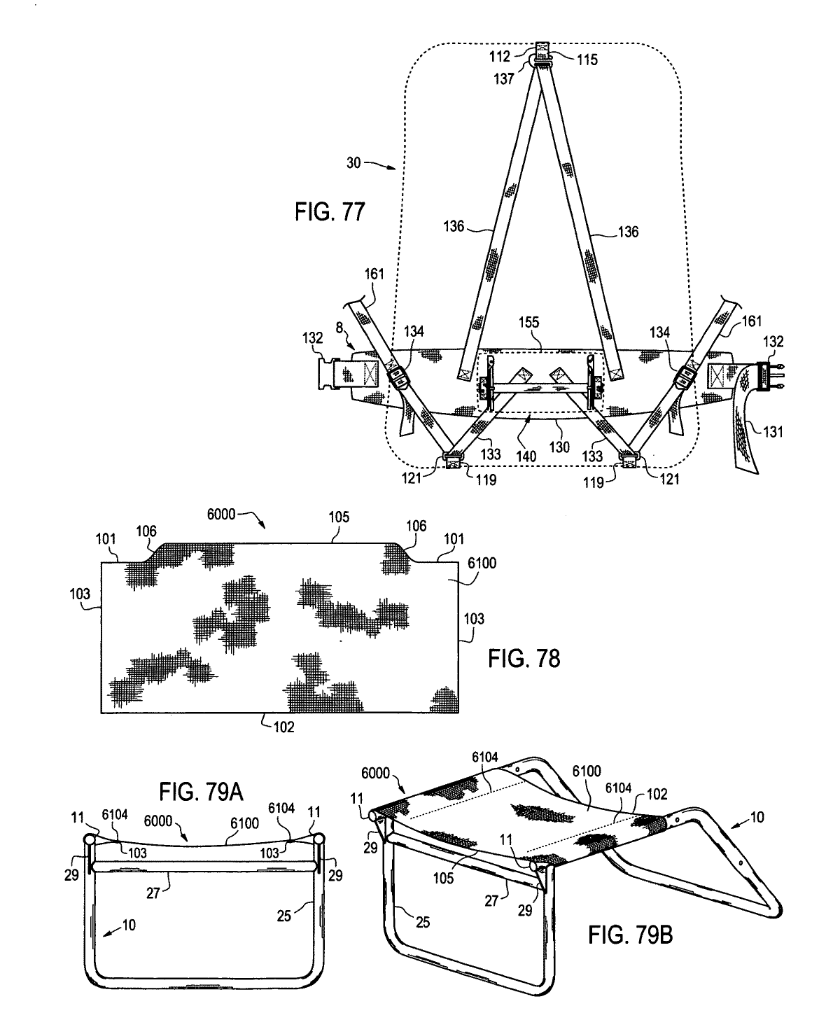

FIG. 77 shows a rear plan view of hip belt assembly 8, oriented as it would be in the first mode, adjusted to a position relative to lower frame member 30 (shown in outline). Referring to FIG. 77, instead of being joined at the area where the ends of suspension strap 136 are joined, coupling straps 133 are joined to rearward side of hip pad 130, closer to the center of hip pad 130 and under headrest support apparatus 140. This provides a different weight distribution on the back and hips of the wearer and helps keep support apparatus 140 and hip pad 130 away from, and from rubbing and/or chaffing, sheet 110.

### An Embodiment of a Seat Assembly

FIG. 78 shows a facing view of a substantially rectangular sheet 6100 used to construct a seat assembly 6000. FIGS. 79A and 79B show front plan and front perspective views of seat assembly 6000 mounted to upper frame member 10, oriented as it would be in the second mode. Referring to FIGS. 78 to 79B, seat assembly 6000 is similar to seat assembly 6 but has lateral side edges 103 that are folded back and joined by, for example, stitching 6104, onto the body portion of sheet 6100 to form an open pair of tube-like hems, each having an opening sufficient to slide over side portions 12 of first section 11. Seat assembly 6000 is mounted to first section 11 before joining section 25 and gussets 29 to section 11. Seat assembly 6000 uses less material than seat assembly 6, and thus is lighter and less costly. As would be apparent to one skilled in the art, many other means of mounting seats to a backpack frame are possible including, for example, those with grommets and rings, or grommets and laces, etc.

### An Embodiment of the Shoulder Strap Assembly

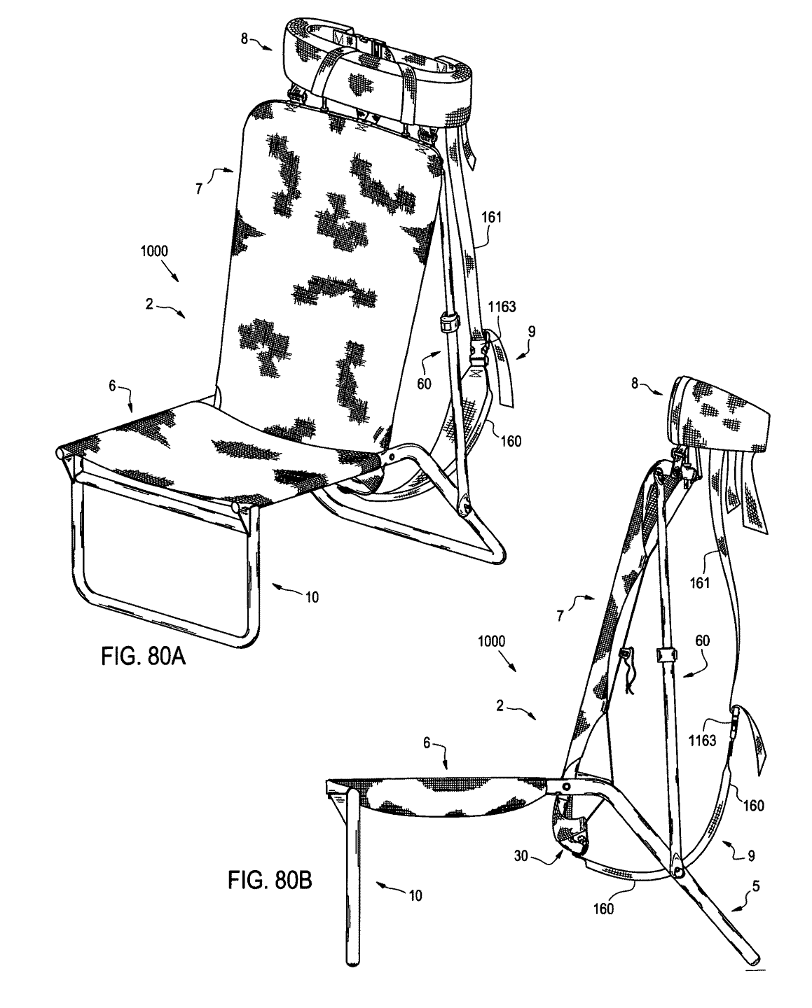

FIG. 80A shows a perspective view of chair 2 with shoulder straps assemblies 9 repositioned to be hanging behind the chair and out of the way of the seat of chair 2; FIG. 80B shows a side plan view of chair 2 from FIG. 80A. In FIGS. 80A and 80B, shoulder straps assemblies 9 include a side-release adjustable buckle 1163 in place of adjustable buckle 163, thus allowing shoulder pads 160 to be detached from straps 161 so that when convertible backpack frame 1000 is converted to chair 2, shoulder pads 160 may be repositioned and reattached to straps 161 behind the chair, as shown, and away from the seat of the chair, providing a less encumbered seat.

In the various embodiments described above and shown in FIGS. 1 to 80B, all straps, unless otherwise stated, may be constructed from, for example, nylon webbing, and may be joined to themselves, other straps, hooks, buckles, or cargo containers, etc. by, for example, stitching.

What has been described and illustrated herein is a preferred embodiment of the invention along with some of its variations. The terms, descriptions, and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A convertible backpack frame useable in a first mode as a backpack frame and useable in a second mode as a chair frame having a reclinable backrest frame, said convertible backpack frame comprising
an upper frame member comprising a first substantially U-shaped section having a V-shaped contour at both lateral sides forming upwardly extending side portions and a rearwardly extending lower portion, and a rearwardly extending second substantially U-shaped section disposed proximate and substantially perpendicular to the upper end of said side portions,
a substantially rectangular lower frame member, pivotably coupled to said upper frame member about a transverse axis proximate said V-shaped contours, and
a first means to control the orientation of said upper frame member with respect to said lower frame member to thereby allow said convertible backpack frame to be in said first mode oriented as said backpack frame or in said second mode oriented as said chair frame having said reclinable backrest frame that is adjustable to any of a plurality recline positions,
whereby in said first mode, said upper frame member provides the upper structure of said backpack frame and said lower frame member provides a backrest frame for said backpack frame, and in said second mode said upper frame member provides the seat frame members and leg members of said chair frame and said lower frame member provides said reclinable backrest frame for said chair frame.

2. The convertible backpack frame of claim 1 wherein said first means includes a plurality of lockable telescoping frame members, wherein one said lockable telescoping frame member is disposed at each lateral side of said convertible backpack frame, and one end of each said lockable telescoping frame member is pivotably coupled to the respective lateral portion of said lower portion and the opposite end of each said lockable telescoping frame member is coupled proximate to the respective lower corner of said lower frame member.

3. The convertible backpack frame of claim 1 wherein said upper frame member and said lower frame member are constructed from hollow tubing material.

4. The convertible backpack frame of claim 1 wherein said first U-shaped section and said second U-shaped section are joined by welding or are detachably attached by fittings.

5. The convertible backpack frame of claim 1 wherein said upper frame member is comprised of detachable sections.

6. The convertible backpack frame of claim 1 wherein said lower frame member comprises an inverted upper third substantially U-shaped section having ends that are slidably attached to the ends of a lower fourth substantially U-shaped section.

7. The convertible backpack frame of claim 1 wherein said lower frame member is disposed between the lateral sides of said upper frame member.

8. The convertible backpack frame of claim 1, further including a first crossbar section disposed between and proximate the ends of said second U-shaped section.

9. The convertible backpack frame of claim 1, further including a second crossbar section disposed between the lateral sides and proximate to the upper portion of said lower frame member.

10. The convertible backpack frame of claim 1 wherein the crossbars portions of said lower frame member are contoured rearwardly.

11. The convertible backpack frame of claim 1 wherein said lower frame member has a substantially beaker-shaped face wherein the lower end of said lower frame member is substantially wider than the upper end of said lower frame member.

12. A convertible backpack frame useable in a first mode as a backpack frame and useable in a second mode as a chair frame having a reclinable backrest frame, said convertible backpack frame comprising
an upper frame member comprising a first substantially U-shaped section having a V-shaped contour at both lateral sides forming upwardly extending side portions and a rearwardly extending lower portion, a rearwardly extending second substantially U-shaped section disposed proximate and substantially perpendicular to the upper end of said side portions, and a first crossbar section disposed proximate and between the ends of said second U-shaped section,
a substantially rectangular lower frame member, pivotably coupled to said upper frame member about a transverse axis proximate said V-shaped contours, comprising an inverted upper third substantially U-shaped section having ends that are slidably attached to the ends of a lower fourth substantially U-shaped section, and a second crossbar section disposed between and proximate the upper ends of said fourth U-shaped section, and
a plurality of telescoping frame members, each comprising a plurality of sections slidably coupled together and a means to prevent sliding therebetween, one said telescoping frame member disposed at each lateral side of said convertible backpack frame wherein one end of each said telescoping frame member is pivotably coupled to the respective lateral side of said lower portion and the opposite end of each said lockable telescoping frame member is coupled proximate to the respective lower corner of said fourth U-shaped section,
whereby in said first mode, said upper frame member provides the upper structure of said backpack frame and said lower frame member provides a backrest frame for said backpack frame, and in said second mode said upper frame member provides the seat frame members and legs members of said chair frame and said lower frame member provides said reclinable backrest frame for said chair frame, and
said telescoping frame members provide a means to control the orientation of said upper frame member with respect to said lower frame member to thereby allow said convertible backpack frame to be in said first mode oriented as said backpack frame or in said second mode oriented as said chair frame having said reclinable backrest frame that is adjustable to any of a plurality of recline positions.

13. The convertible backpack frame of claim 12, further including
a seat assembly comprising a first flexible sheet and a means for mounting said first flexible sheet to said side portions,
a backrest assembly comprising a second flexible sheet and a means for mounting said second flexible sheet to said lower frame member,
a plurality of shoulder strap assemblies, each comprising a shoulder pad and a means for securing said shoulder pad to said convertible backpack frame, and
whereby said first flexible sheet is of sufficient size to provide a sitting surface for said chair frame in said second mode, said second flexible sheet is of sufficient size to provide a backrest surface for said backpack frame in said first mode and for said chair frame in said second mode, and said shoulder strap assemblies provide a means for securing the forward side of said backpack frame in said first mode upon the back of a person.

14. The convertible backpack frame of claim 12, further including
a seat assembly comprising a first flexible sheet and a means for mounting said first flexible sheet to said side portions,
a backrest assembly comprising a second flexible sheet and a means for mounting said second flexible sheet to said lower frame member,
a plurality of shoulder strap assemblies, each comprising a shoulder pad and a means for securing said shoulder pad to said convertible backpack frame, and
a hip belt assembly comprising a hip pad that includes a means for cinching said hip pad, a means for coupling said hip pad to said lower frame member, a means for suspending said hip pad from said lower frame member in said first mode, and a means for supporting said hip pad on said lower frame member in said second mode,
whereby said first flexible sheet is of sufficient size to provide a sitting surface for said chair frame in said second mode, said second flexible sheet is of sufficient size to provide a backrest surface for said backpack frame in said first mode and for said chair frame in said second mode, said shoulder strap assemblies provide a means for securing the forward side of said backpack frame in said first mode upon the back of a person, and
said hip belt assembly in said first mode provide a means for securing said backpack frame upon the hips of said person and in said second mode provides a headrest for said chair frame.

15. The convertible backpack frame of claim 12, wherein said first U-shaped section, said second U-shaped section, and said first crossbar section are joined by welding or are detachably attached by a first set of fittings, and said third U-shaped section, said fourth U-shaped section, and said second crossbar section are joined by welding or are detachably attached by a second set of fittings.

16. The convertible backpack frame of claim 12, wherein said first U-shaped section, said second U-shaped section, said first crossbar section, said third U-shaped section, said fourth U-shaped section, said second crossbar section, and said sections of said telescoping frame members are constructed from hollow tubing material.

17. The convertible backpack frame of claim 12, further including one or more cargo compartments each comprising one or more containers and a means for detachably attaching said compartments to said backpack frame.

18. A method of utilizing a hip pad as a first means for supporting a backpack frame upon the hips of a person and as a second means for providing a headrest for a chair convertible from said backpack frame, comprising the steps of:
providing said backpack frame that is convertible to said chair, said backpack frame having said hip pad coupled to said backpack frame at a first position suitable for providing said first means, converting said backpack frame to said chair,
repositioning said hip pad on said chair at a second position suitable for providing said second means.

19. The method of claim 18 comprising the further steps of:
repositioning said hip pad on said backpack frame at said first position,
converting said chair back to said backpack frame.

20. The method of claim 18 comprising the further steps of
providing one or more cargo compartments each comprising one or more containers and a means for detachably attaching said compartments to said backpack frame,
detaching said compartments from said backpack frame before converting said backpack frame to said chair,
attaching said compartments to said backpack frame after converting said chair back to said backpack frame.
